(19) United States
(12) Patent Application Publication
(10) Pub. No.: US 2026/0285023 A1
(43) Pub. Date: Sep. 24, 2026

(54) WOODEN TRANSACTION CARDS AND METHODS OF MAKING THE CARDS

(71) Applicant: Copecto GmbH, Wiesbaden (DE)

(72) Inventor: David Finn, Fuessen Weissensee (DE)

(21) Appl. No.: 19/571,814

(22) Filed: Mar. 19, 2026

Related U.S. Application Data
(60) Provisional application No. 63/776,126, filed on Mar. 23, 2025.
(60) Provisional application No. 63/780,169, filed on Mar. 29, 2025.
(60) Provisional application No. 63/811,810, filed on May 25, 2025.
(60) Provisional application No. 63/811,792, filed on May 25, 2025.
(60) Provisional application No. 63/828,076, filed on Jun. 22, 2025.
(60) Provisional application No. 63/828,074, filed on Jun. 22, 2025.
(60) Provisional application No. 63/828,072, filed on Jun. 22, 2025.
(60) Provisional application No. 63/880,654, filed on Sep. 12, 2025.
(60) Provisional application No. 63/880,477, filed on Sep. 12, 2025.
(60) Provisional application No. 63/898,576, filed on Oct. 14, 2025.
(60) Provisional application No. 63/898,574, filed on Oct. 14, 2025.
(60) Provisional application No. 63/915,242, filed on Nov. 11, 2025.
(60) Provisional application No. 63/915,204, filed on Nov. 11, 2025.
(60) Provisional application No. 63/915,737, filed on Nov. 12, 2025.
(60) Provisional application No. 63/918,251, filed on Nov. 15, 2025.
(60) Provisional application No. 63/918,241, filed on Nov. 15, 2025.
(60) Provisional application No. 63/922,184, filed on Nov. 21, 2025.

(30) Foreign Application Priority Data
Mar. 12, 2026 (WO) PCT/EP2026/056890

(51) Int. Cl. B32B 37/10; B32B 7/12; B32B 21/14; B32B 37/12; B32B 38/00; B32B 38/16

(52) U.S. Cl. CPC B32B 37/10; B32B 7/12; B32B 21/14; B32B 37/12; B32B 38/0004; B32B 38/164; B32B 2038/166; B32B 2307/718; B32B 2307/7376; B32B 2425/00

(57) ABSTRACT

A wooden transaction card (WTC; smartcard (SC)) having several wooden layers (WL, SWL, PWL), reinforcement layers (RL) and adhesive layers (AL) and an in-card booster antenna circuit (BAC) incorporated in an adhesive layer of a core subassembly (CS). The wooden layers may be sliced or rotary peeled, preconditioned at the mill with a moisture content of 8%, and may be prepressed to a desired thickness. The reinforcement layers may comprise a substrate layer (SL) of nonwoven fabric and coated on one or both sides with an adhesive layer. The core subassembly (CS) is prelaminated to a defined thickness before final lamination involving a compression process of reducing the thickness of the stack-up of wood veneer, reinforcement and adhesive layers to an ISO conforming thickness of 760-800 μm, with pressure between 200 N/cm² and 850 N/cm² at a temperature between 135° C. and 150° C.

### CROSS-REFERENCES TO RELATED APPLICATIONS

This application claims priority (filing date benefit) from the following as:
a continuation-in-part of PCT/EP2026/056890 filed 12 Mar. 2026
   which claims priority from the following US provisional applications
   U.S. 63/915,737 filed 12 Nov. 2025
   U.S. 63/898,576 filed 14 Oct. 2025
   U.S. 63/880,477 filed 12 Sep. 2025
   U.S. 63/828,072 filed 22 Jun. 2025
   U.S. 63/811,792 filed 25 May 2025
   U.S. 63/771,124 filed 13 Mar. 2025
a nonprovisional filing of US 63/922,184 filed 21 Nov. 2025
a nonprovisional filing of U.S. 63/918,251 filed 15 Nov. 2025
a nonprovisional filing of U.S. 63/918,241 filed 15 Nov. 2025
a nonprovisional filing of U.S. 63/915,737 filed 12 Nov. 2025
a nonprovisional filing of U.S. 63/915,242 filed 11 Nov. 2025
a nonprovisional filing of U.S. 63/915,204 filed 11 Nov. 2025
a nonprovisional filing of U.S. 63/898,576 filed 14 Oct. 2025
a nonprovisional filing of U.S. 63/898,574 filed 14 Oct. 2025
a nonprovisional filing of U.S. 63/880,654 filed 12 Sep. 2025
a nonprovisional filing of U.S. 63/880,477 filed 12 Sep. 2025
a nonprovisional filing of U.S. 63/828,076 filed 22 Jun. 2025
a nonprovisional filing of U.S. 63/828,074 filed 22 Jun. 2025
a nonprovisional filing of U.S. 63/828,072 filed 22 Jun. 2025
a nonprovisional filing of U.S. 63/811,810 filed 25 May 2025
a nonprovisional filing of U.S. 63/811,792 filed 25 May 2025
a nonprovisional filing of US 63/780,169 filed 29 Mar. 2025
a nonprovisional filing of US 63/776,126 filed 23 Mar. 2025
   all of which are incorporated in their entirety by reference herein.

### FIELD OF THE INVENTION

This invention relates to transaction cards (also known as smartcards, either of which may be referred to herein simply as “cards”) and, more particularly, to cards incorporating layers (or veneers) of wood, or other materials which may be eco-friendly or biodegradable. Cards having a significant wood content may be referred to as “wooden transaction cards”, or the like. This may include cards having contactless (RFID-enabled) capability or dual interface (contact and contactless) capability.

Some features of the invention(s) disclosed herein may include incorporating either a booster antenna (BA) or a booster antenna circuit (BAC) or a coupling frame (CF) into the card to facilitate the contactless capability.

Cards incorporating a booster antenna (BA) are known, such as may be disclosed in U.S. Pat. No. 9,195,932 2015 Nov. 24 (Finn et al.), incorporated by reference herein

Cards incorporating coupling frames (CF) are known, such as may be disclosed in U.S. Pat. No. 9,390,364 2016 Jul. 12 (Finn et al.), incorporated by reference herein.

Some features of the invention(s) disclosed herein may include incorporating one or more of the following into the construction of the card: a laser engraved QR code, features which have been laser ablated or mechanically engraved, a magnetic stripe, a holographic foil, a topcoat protecting underlying artwork which can be laser etched with personalization data.

Some of the disclosure(s) herein may relate to transaction cards made from material other than wood.

### BACKGROUND OF THE INVENTION

Most of the wood cards for access control, such as those used as keycards in hotels have a thickness of 1.4 mm, and are unsuitable for use in the payment industry, requiring an ISO thickness of 0.76 mm±0.08 mm. And those “all wood” cards which are within ISO thickness bend easily and warp over time. To achieve card body stiffness and longevity, some producers have densified a stack of wood veneers comprising outer layers of wood veneer having a thickness of 600 μm and inner layers having a thickness of 200 μm, with the inner layers sandwiching an inlay incorporating a booster antenna (BA) or a booster antenna circuit (BAC) with a thickness of 100 μm, as disclosed in US 2024/0001585. However, there are a number of challenges in pre-conditioning to remove moisture and densifying a stack of wood veneers at stepped elevated pressure levels and the post manufacturing processes of impregnating, printing, coating, singulating, applying security elements, engraving features and implanting the chip module while at the same time achieving high production yields and keeping the manufacturing cost down. In use, wooden payment cards have also bowed, warped and delaminated in the field which has been a major concern for the issuing banks and payment schemes. As wooden cards are the eco-friendly alternative to PVC cards, durability and insensitivity to the environment, especially humidity is a prerequisite.

### Some Patents and Publications of Interest

The following patents and/or publications (“references”) may be of interest or relevant to the invention(s) disclosed herein, and some commentary may be provided to distinguish the invention(s) disclosed herein from the following references.

US 2024/0001585 (4 Jan. 2024; Swiss Wood Solutions; Chanana et al.), entitled “Densified hygroscopic materials and products made thereof”, incorporated by reference herein, discloses a method for densifying a hygroscopic material. The method is for hygroscopic material which may be a natural hygroscopic material or wood. The method comprises the steps of providing the hygroscopic material to be densified; pre-conditioning of the hygroscopic material by adjusting the moisture content of the hygroscopic material to a value within a predefined moisture range, if required; simultaneously heating and pressing the gas-tight packed hygroscopic material under predefined temperature and pressure conditions, whereby the moisture content of the hygroscopic material is kept constant; and obtaining a densified material. Reference is also made to WO 2022/112610 A1. FIGS. 1, 3, 4 and 5 thereof are of particular interest, are reproduced as FIGS. 1, 2, 3 and 4 herein, and are discussed hereinbelow.

US 2022/0184931 (16 Jun. 2022; Kona I Co, Ltd.; Shin et al.), entitled “Card including wood sheet, and method of manufacturing the same”, incorporated by reference herein, discloses a method of manufacturing a card includes the steps of: processing a wood sheet; stacking the wood sheet on an inlay sheet including an antenna that will be connected to a COB chip; milling an area corresponding to the chip on the wood sheet, and forming a residual layer of a thickness smaller than that of the wood sheet; exposing end portions of the antenna passing through the residual layer from the inlay sheet located under the residual layer of the wooden sheet; and electrically connecting the chip and the end portions of the antenna. FIG. 1 is of particular interest, is reproduced as FIG. 5 herein, and is discussed hereinbelow.

US 2019/0311238 (10 Oct. 2019; Capital One; Cepress et al.), entitled “Multilayer composite backed card”, incorporated by reference herein, describes a transaction card. The transaction card may include a first card component of non-plastic card material having a thickness of no more than about 0.3 mm, a second card component of composite fiber material having a thickness of no more than about 0.3 mm, and an adhesive for affixing the first layer and second layer together. The non-plastic card material may be selected from a group including wood, bamboo, steel, copper, aluminum, silver, gold, platinum, granite, marble, and slate and the composite fiber material may include at least one of a glass fiber composite, a carbon fiber composite, or a natural fiber composite.

US 2010/0033297 (11 Feb. 2010; UPM Raflatac; Patovirta), entitled “Layered board structure”, incorporated by reference herein, discloses a layered board structure, which comprises at least two or more veneer layers, which are joined to one another by means of adhesive. In accordance with the invention, the layered board structure comprises further at least one intelligent identifier, which is arranged between said two veneer layers of the layered board structure.

US 2008/0020200 (24 Jan. 2008; Neenah Paper; Stokes et al.), entitled “Formaldehyde-free paper backed veneer products and methods of making the same”, incorporated by reference herein, discloses a paper backed veneer having a veneer laminated to a paper backing sheet saturated with a formaldehyde-free binder composition. The formaldehyde-free binder composition includes a curable latex polymer and a crosslinking agent. The latex polymer can include functionalized groups, such as carboxyl groups, to aid curing. The crosslinking agent can be an epoxy resin. Also, a method of making paper backed veneers is generally disclosed.

US 2008/0268273 (30 Oct. 2008; The Diller Corporation; O'Brien et al.), entitled “Wood veneer surfaced decorative laminate product and method of making same”, incorporated by reference herein, discloses a wood veneer surfaced laminate and method of making it are provided which produces a product having the appearance of a natural wood product, but with the toughness, moisture resistance, stain resistance, impact resistance, and abrasion resistance of melamine resin surfaced laminate products. The wood veneer surfaced laminate is made by providing a sheet of a natural or engineered wood veneer; impregnating the sheet with a first liquid curable resin such that said liquid resin substantially completely impregnates the sheet; coating a second liquid curable resin onto a surface of the sheet; laminating the sheet to a core while curing the resins to form a natural or engineered wood veneer surfaced laminate. Claim 1 of US 2008/0268273:
A method of making a wood veneer surfaced laminate comprising, providing a sheet of a natural or engineered wood veneer; impregnating said sheet with a first liquid curable resin such that said liquid resin substantially completely penetrates said sheet; coating a second liquid curable resin onto a surface of said sheet; laminating said sheet to a core to form a natural or engineered wood veneer surfaced laminate; and curing said first and second resins.

U.S. Pat. No. 10,832,115 (10 Nov. 2020; Capital One Services, LLC; Suthar), entitled “Wood inlay card and method for making the same”, incorporated by reference herein, discloses a transaction card construction and a method for making a transaction card. The transaction card construction comprises an inlay component comprising wood and a housing component. The inlay may comprise a wood or wood-containing layer and a backer layer. The backer layer may comprise the same or a different wood or wood-containing layer, or a nonwoven fiber material. FIG. 11 is of particular interest, is reproduced as FIG. 6 herein, and is discussed hereinbelow.

U.S. Pat. No. 10,572,784 (25 Feb. 2020; Wells Fargo Bank; Kushner et al.), entitled “Wood transaction instrument”, incorporated by reference herein, discloses a method of manufacturing a densified wood transaction instrument includes boiling a sheet of wood in a chemical solution, compressing the boiled sheet of wood using a die in a press to form one or more features in the sheet of wood, during the compressing of the boiled sheet of wood, heating the boiled sheet of wood to create a sheet of densified wood, and attaching one or more payment elements to at least one of the one or more features formed in the sheet of densified wood to form a sheet of one or more densified wood transaction instruments.

U.S. Pat. No. 10,350,819 (16 Jul. 2019; Sappi North America; Murray), entitled “Release webs and textured products”, incorporated by reference herein, discloses processes and equipment for manufacturing materials that have a textured surface formed by applying a first texture to a curable coating, curing the coating, and then embossing a second, different texture over the first texture. The disclosure also features textured materials, including both release webs for use in replicative casting processes and finished products in sheet, board, plate or web form. Claim 1 of U.S. Pat. No. 10,350,819:
A release web comprising: a substrate; and a coating layer disposed on at least one surface of the substrate, the coating layer including a surface effect to be replicated during casting, wherein the surface effect comprises a first, predetermined micro- or nanoscale three-dimensional texture and a second, predetermined macro-scale three-dimensional texture; wherein the first texture is coextensive with the second texture.

U.S. Pat. No. 10,163,050 (25 Dec. 2018; Capital One Services, LLC; Suthar), entitled “Wood inlay card and method for making the same”, incorporated by reference herein, discloses A transaction card construction and a method for making a transaction card are provided for improving card performance. The transaction card construction comprises an inlay component comprising wood and a housing component. The inlay may comprise a wood or wood-containing layer and a backer layer. The backer layer may comprise the same or a different wood or wood-containing layer, or a nonwoven fiber material. Reference is also made to U.S. Pat. No. 10,354,180 (Suthar; 16 Jul. 2019), U.S. Pat. No. 10,354,179 (Suthar; 16 Jul. 2019), U.S. Pat. No. 10,152,670 (Suthar; 11 Dec. 2018).

U.S. Pat. No. 9,527,333 (27 Dec. 2016; Optimum Card Solutions; Lamb et al.), entitled “Unique method to manufacture paper substrate transaction cards”, incorporated by reference herein, discloses an in-line process is provided for economical manufacture of attractive flat paper substrate transaction cards with or without an RFID chip embedded therein. In the user-friendly process, one or more continuous webs from roller paper are automatically fed and sequentially advanced through a series of operations and stations in a single pass.

U.S. Pat. No. 8,192,830 (5 Jun. 2012; S.D. Warren Company; Blenkhorn et al.), entitled “Materials having a textured surface and methods for producing same”, incorporated by reference herein, discloses processes and equipment for forming a variety of textured materials, including both release webs, and finished products such as flooring materials, wall coverings, textured laminates and the like. The processes described herein allow curing radiation to be passed through a texturing medium, rather than through the substrate to which the curable material is applied.

Claim 1 of U.S. Pat. No. 8,192,830

A textured product comprising: a substrate comprising a board or plate; and on the substrate and forming an exposed surface of the product, a cured radiation curable coating having a three dimensional surface texture that reproduces an original three-dimensional pattern with 100% fidelity; wherein the physical properties of the substrate, which has the cured radiation curable coating thereon, are substantially the same as the physical properties of the substrate prior to application and curing of the coating.

U.S. Pat. No. 8,579,201 (12 Nov. 2013; Sustainable Cards; Akesson), entitled “Hybrid cards”, incorporated by reference herein, discloses a hybrid card. The hybrid card includes an organic substrate, a first layer of a substantially organic backer that is securely affixed to a first side of the substrate, a second layer of a substantially organic backer that is securely affixed to an opposite side of the substrate, a first layer of thin-film overlay that is attached to the first layer of backer, a second layer of thin-film overlay that is attached to the second layer of backer. Manufacturing methods for the various embodiments of the hybrid card are also described. Reference is also made to US 2011/0311787.

Claim 1 of U.S. Pat. No. 8,579,201

A hybrid card comprising: a core consisting of a single layer wood substrate; a first layer of a substantially organic backer made from a long-fibrous cellulose material, the first layer being securely affixed to a first side of the core, the first layer being substantially transparent to render the structure of the core visible through the first layer of substantially organic backer; a second layer of a substantially organic backer made from a long-fibrous cellulose material, the second layer being securely affixed to an opposite side of the core, the second layer being substantially transparent to render the structure of the core visible through the second layer of substantially organic backer; a first layer of thin-film overlay that is attached to an outer surface of the first layer of backer; and a second layer of thin-film overlay that is attached to an outer surface of the second layer of backer.

U.S. Pat. No. 7,404,422 (29 Jul. 2008; Eagle Analytical; Kamke et al.), entitled “Viscoelastic thermal compression of wood”, incorporated by reference herein, discloses a high density wood product that is made from low-density wood. The wood product is made using a continuous viscoelastic thermal compression (VTC) process and exhibits high density, strength and dimensional stability, compared to the lower density starting material (typically composite panels such as strand board) from which it is made.

U.S. Pat. No. 5,652,065 (29 Jul. 1997; Weyerhaeuser; Park et al.), entitled “Wood veneers and products therefrom having enhanced strength and stiffness”, incorporated by reference herein, discloses wood veneers having enhanced strength and/or stiffness, wood products made therefrom, and methods for manufacturing such veneers and wood products. A treated veneer having enhanced strength and stiffness has a population of compacted wood cells extending across at least a portion of the length and width dimensions and into the thickness dimension of the veneer to confer an increased density level, and thus increased strength and/or stiffness levels, to the veneer. Interspersed in the compacted wood cells is a non-saturating loading level of a cured rigid thermoset material which maintains compaction of the compacted cells even after prolonged soaking in water. The preferred loading level is just what is required to maintain compaction of the cells. The preferred thermoset material is polyurea which is formed from a polyisocyanate resin applied to at least one major surface of the veneer followed by hot-pressing the veneer. The strength and/or stiffness increase, compared to untreated veneer, is about 10 to 150 percent. Treated veneers can be made into various multiple-ply wood products such as laminated veneer lumber and plywood, thereby providing a way to convert relatively weak lumber from fast-grown trees into premium-grade construction material.

WO 2019/115727 (14 Dec. 2017; Gemalto; Kodjagueuzian et al.), entitled “Method for producing a chip card comprising wood”, incorporated by reference herein, discloses a method for producing a chip card (10A, 11A) comprising a card body (17) comprising wooden sheets (5B, 6B), said method comprising the steps of: providing two wooden sheets (5B, 6B); providing an insert (1) comprising at least one sheet or leaf of metal (3); and inserting the insert (1) between said sheets (5B, 6B) before assembly of all of the elements, the outer faces of the wooden sheets being outwardly oriented and predominantly covering the two main surfaces of the card body (17), said method being characterised in that it comprises a step of printing (15) or fixing a layer of material (14) onto the edge (T) of the card body (17), which is designed to interconnect layers in the region of the edge. The invention also relates to a corresponding card produced by the method.

WO 96/23276 (1 Aug. 1996; Eco-Card Sweden AB; Zetterlund et al.), entitled “Card”, incorporated by reference herein, discloses a card (1; 1′) comprising at least one information carrier (6; 6′), for example a telephone card or a credit card, wherein the card (1; 1′) comprises at least two layers (8, 9; 8′, 9′) made of wood connected to each other, wherein each layer (8, 9, 10; 8′, 9′, 10′) has a main fiber direction and that the fiber directions of the layers (8, 9, 10; 8′, 9′, 10′) are orientated in at least two different directions. Reference is also made to PCT/SE96/00063.

EP 3 985 563 (20 Apr. 2022; Exceet Card Austria GmbH—Skidata GmbH; Irlinger et al.), entitled “Chip card”, incorporated by reference herein, discloses a chip card (1) comprising a chip (9) which is designed as a layered composite, the visible sides (2) of which are designed as layers of wood veneer, with a core designed as a prelaminate (3) being arranged between the visible sides (2) which has a paper substrate (4) connected on both sides to a layer (5) of paper or cardboard, on which the chip (9) and, if present, an antenna (10) are arranged. Claim 1 recites:
Chip card (1) comprising a chip (9), characterized in that it is designed as a layered composite whose visible sides (2) are designed as layers of wood veneer, with a core designed as a prelaminate (3) being arranged between the visible sides (2). which has a paper substrate (4) connected on both sides to a layer (5) of paper or cardboard, on which the chip (9) and, if present, an antenna (10) are arranged. Chip card (1) according to claim 1, characterized in that an intermediate layer (6) of nonwoven material is provided between the prelaminate (3) and the respective visible side (2) of the chip card (1) made of wood veneer.

EP 4 506 853 (12 Feb. 2025; Giesecke & Devrient; Fernandez et al.), entitled “Method for manufacturing a smart card with a wooden layer”, incorporated by reference herein, discloses a method (150) for manufacturing a smart card (10). The method comprises: in a first step (152), providing a front layer (111), a rear layer (112), and an antenna layer (113) of a smart card body (11), wherein at least the front layer (111) comprises wood; in a second step (154), applying thermal energy to the front layer (111) by a thermal energy source (50, 70, 80) in order to heat the front layer (111) for a first predetermined period of time to a first predetermined temperature; in a third step (156), joining the front layer (111), the rear layer (112), and the antenna layer (113) with the antenna layer (113) being arranged between the front layer (111) and the rear layer (112). The third step (156) is carried out after the second step (154) and prior to the front layer (111) being joined with the antenna layer (113).

DE 198 03 262 C2 (27 Apr. 2000; Dexle et al.), entitled “Veneer system of high flexibility and method for producing same”, incorporated by reference herein, discloses in the set of claims the following: 1. Use of a single fleece for backing veneer systems, characterized in that the single fleece is hydroentangled. 2. Use of a single fleece according to claim 1, characterized in that the single fleece has a splitting strength of more than 450 kPa with a thickness of more than 0.1 mm. 3. Use according to claim 1 or 2, characterized in that the single fleece is a wet fleece. 4. Use according to claim 3, characterized in that the single fleece is a mixture of cellulose and polyester fibers bound with a binder, preferably an acrylate dispersion. 5. Use according to claim 1 or 2, characterized in that the single fleece is a dry nonwoven. 6. Use according to claim 5, characterized in that the dry nonwoven includes polyester fibers or other plastic fibers. 7. Use according to one of claims 1 to 6, characterized in that the single fleece comprises a coating. (translated from German)

### ADDITIONAL REFERENCES

CN112567386A entitled “Card comprising a wood laminate and method for making same”;
JP7149335B2 entitled “Card with wooden sheet and its manufacturing method”;
WO2024144271A1 entitled “Solid-wood card having chip equipped therein”;
KR20230031722A entitled “Solid wood card attached chip”;
KR102621194B1 entitled “Solid wood card attached chip”;
KR20160042568A entitled “Hybrid card having wood sheet and preparing method . . . ”;
KR20190012296A entitled “A sliced veneer credit card process and sliced veneer credit card”;
KR20230000101A entitled “Wooden card and manufacturing method thereof”;
KR20240107305A entitled “Wood card to be embedded chip”; and
US 2016/0004948 entitled “Method for producing a paper carrier card . . . ”

### Some Definitions

Some of the following terms may be used or referred to, herein.

### Wood Veneer

Veneer is produced by slicing or rotary cutting a tree log in thin layers with a blade. The standard thickness of the veneer is 0.6 mm. The veneer retains the natural look and feel of real wood as well as its unique properties, showing authentic color and pattern variations. Wood veneers are available in more than 165 different standard wood species.

Reference is made to: internet.decospan.com/en/; internet.dieterle.com/furniere; and internet.formwood.com/.

Veneers are available in a variety of wood species such as ash, aspen, bamboo, birch, birds eye maple, burl, cathedral walnut, cherry, cherry cathedral, curly maple, Douglas fir, eastern red cedar, ebony, fir, hard ash, hard maple, Hawaiian Koa, mahogany, maple, oak, oak cathedral, olivewood, poplar, red cedar, rosewood, sassafras, teak, walnut, wenge, western red cedar, white oak, yellow poplar, zebra, etc. The standard veneer format may be 24 inches square (610 μm×610 μm), with a thickness ranging from 127 μm (5 mils), 140 μm (5.5 mils), 150 μm (6 mils), 178 μm (7 mils), 203 μm (8 mils), 254 μm (10 mils) to 305 μm (12 mils). The veneer may be perforated for drop acoustics. Veneers may be supplied with a fleece as backer.

Wood veneers with a thickness under 203 μm are generally rotary peeled, whereas wood veneers with a thickness above 500 μm are typically sliced.

### Methods of Cutting Wood Veneer

### Lathe Peeling or Full Round Rotary Slicing

In rotary slicing, a whole round log is mounted on a lathe and turned against a blade. Rotary cutting or “peeling” of a log produces a continuous sheet of veneer as if the tree were being “unrolled”. This is the most economical method of cutting. Veneer cut this way varies in pattern as it cuts through the successive layers of growth rings. Rotary cut veneer can be wide enough to produce full-sheet (single piece) faces.

The following hardwoods can be used as raw materials for the manufacture of peeled veneer: cherry, birch, maple, oak, walnut, poplar, ash, elm, beech, hornbeam, alder, aspen and linden.

The most widely used species are birch, alder and aspen. Birch is considered the best species for peeling because it has the following advantages: low degree of tapering; uniformity of texture and high strength.

This method allows the cutting of micro thin wood veneers in a continuous web having a thickness in the range from 127 μm (5 mils), 140 μm (5.5 mils), 150 μm (6 mils) to 178 μm (7 mils).

### Plain Slicing

In plain slicing, the most common process for veneer manufacturing, a half, third or quarter of a log (the flitch) is mounted on a vacuum flitch table with the heart away from the blade. The cut is then made with the blade parallel to the length of the log. Flat slicing or plain slicing produces consecutive leaves of veneer and produces the standard appearance of veneer (the “cathedral” or flame shaped arch) that exemplifies plain sliced cherry, ash, oak and other species. This cut of veneer is ideally suited for furniture because of the consistency in its grain, and the ability to match sequences of leaves.

The standard thickness of the veneer is typically 525 μm (~21 mils), 550 μm (~22 mils) or 600 μm (~24 mils), but alternative machine settings can achieve a thickness of 203 μm (8 mils), 254 μm (10 mils) or 305 μm (12 mils).

### Warpage

Warpage of laminated wood veneers is defined as the deviation of the geometry of a laminated panel from an initial state of flatness. A balanced stack-up construction, proper material handling and storage, correct lamination parameters, and post lamination drying and storage (i.e. conditioning period to equalize) are steps to minimize the effect of warpage.

### Moisture Content—Wood Veneers

The materials should be laminated with their moisture content in the 6-9 percent range. And, since balanced panel construction is essential to prevent warpage, the same thickness and grade veneer should be used on both sides.

### Break the Grain

“Break the Grain” in the context of wood veneers refers to the practice of creating designs where the grain pattern of the veneer is interrupted or altered, often for decorative purposes. This is achieved by using different cutting techniques or by manipulating the veneer after it's been cut.

### Veneer Edge Banding

It is made from actual slices of wood that have been pre-sanded and layered together on a fleece or paper carrier. Veneer Edge Banding is available in both finished and unfinished depending on whether a plywood is going to be painted or stained. This edge banding is most commonly used to make a board seem like a solid piece of wood (but at a fraction of the price).

### Wood Glue (PVAc)

PVAc wood glues, often also called white glues, are produced by polymerizing vinyl acetate or copolymerizing with other monomers and are thermoplastic adhesives. Modern wood glues are now predominantly solvent-free. Polyvinyl acetate is a widely available adhesive used for porous materials like wood, paper, fleece and cloth. Thermoplastic PVA may be altered to function as a thermoset by the addition of a hardener.

### Backers

Backings strengthen wood veneers to make them sturdier for easy handling. Backings reinforce wood grains to make them more flexible, reducing the potential damage to the wood from bending. Flame resistance and water resistance versions are available. Backings are pre-coated with a dry film adhesive. Available in rolls or sheets. Typical thicknesses for application in smartcards range from 40 μm, 75 μm and 100 μm. Backer material types include: clear, polyester, fleece, woven, cellulose, thin paper, thick paper, melamine, foam, fiber or composites.

### Wetlaid Nonwoven

A wetlaid nonwoven is a type of fabric created by dispersing short fibers in a liquid, typically water, and then depositing the suspension onto a moving screen to form a web. The water is then removed, and the remaining fibers are bonded together, either through mechanical entanglement, chemical binders, or heat, to create a sheet-like material. This process is similar to papermaking but uses a wider range of fibers and bonding methods.

Wetlaid nonwoven fabric is typically manufactured with cellulose and synthetic fibers (e.g. polyester fibers) bonded with a latex binder.

### Adhesive Coated Fleece

An adhesive coated fleece is applied to a wood veneer for reinforcement. It comprises a fleece material coated with wood glue. The fleece mainly consists of long-fibrous cellulose. Synthetic fibers (such as polyethylene (PE) or polyester fibers) as well as a latex binder are admixed for increasing tear resistance and flexibility. The glue coating is applied from a water-based system. In combination with sufficient press temperature and pressure it provides a very heat- and water-resistant bond. The closed surface of the glue avoids penetration of water or solvents. Adhesive coated fleece, a nonwoven material coated on one side with glue, may have a thickness of 125 μm with a maximum processing temperature of 140° C. The fleece carrier may also be coated on both sides having an overall thickness of 150 μm.

### Glass Fiber Nonwovens

Glass fiber nonwovens are sheet or web structures made by bonding together randomly dispersed glass fibers through mechanical, thermal, or chemical processes, but without weaving or knitting. They are used in various applications, due to their versatility and ability to be engineered with specific properties. They offer benefits like dimensional stability, tear strength, and resistance to moisture, mold, and mildew.

### Nonwovens of Glass Fiber and Fleece

In a hybrid fleece and glass fiber construction (with approximately 70% glass fiber, PE fibers and 2% binder), also known as nonwoven fiberglass fleece fabric, the mechanical strength and tear resistance can be significantly improved.

### Hydroentangled Nonwovens

Hydroentanglement, also known as spun-lacing, is a method of creating nonwoven fabrics by using high-pressure water jets to entangle fibers. This process involves passing a web of fibers through multiple rows of fine, high-velocity water jets, which cause the fibers to interlock and form a fabric-like structure. Hydroentangled nonwovens are known for their softness, strength, high absorbency, and good uniformity.

Nonwoven fabrics can be made from various materials, including polyethylene (PE) fibers. PE is a type of polymer that can be used to create soft, comfortable, and durable nonwoven textiles. The process often involves creating a web of fibers, either by extruding PE or using existing PE fibers, and then bonding them together through various methods.

### Thermowood

Wood properties naturally enhanced with heat and steam. It is a sustainable timber material produced using chemical-free heat treatment.

### Amino Resins

They are a class of synthetic thermosetting polymers created by reacting formaldehyde with amino compounds, primarily including urea-formaldehyde (UF) and melamine-formaldehyde (MF) resins, which undergo a two-stage reaction to form a three-dimensional crosslinked network structure.

### Phenolic Adhesive Film

Phenolic surface films (PSF) are resin impregnated industrial overlays designed to improve the surface characteristics of wood-based panels. Phenolic adhesive film (thermoset) in various colors may have a thickness of 110 μm with a processing temperature of 130-135° C.

### Melamine Film

Exterior plywood coated with melamine film is made by pressing paper saturated with melamine resin on a surface of exterior plywood. The surface coated with the film improves their resistance to abrasion and protects the sheets from moisture. Melamine impregnated paper may have a thickness of 140 μm with a processing temperature of 130-135° C.

A melamine film impregnated with adhesive having an overall thickness of 110 μm may comprise of 40 g/m² of paper and 80 g/m² of adhesive with a total weight of 120 g/m².

### Printing Primer

A printing primer is a coating applied to a surface before printing to improve ink adhesion, control surface tension, and ensure a uniform, smooth surface for ink droplets. By creating an intermediate layer, a primer makes it easier for inks to bond to the substrate, resulting in higher-quality prints with enhanced color vibrancy, clarity, and sharpness.

### Acrylic

The term “acrylic” represents a family of petroleum-based thermoplastics made from the derivation of natural gas. It is any compound that includes acrylic acid or related compounds called acrylates.

Acrylic resin is a common ingredient in latex paint (aka emulsion paint). Latex paints with a greater proportion of acrylic resin offer better stain protection, greater water resistance, better adhesion, greater resistance to cracking and blistering, and resistance to alkali cleaners compared to those with vinyl.

Acrylic resins are materials which when added to latex increases its gloss properties, mechanical durability (i.e. scratch resistance) and improves the gloss over vinyl-only resins.

Acrylic paint is a fast-drying paint made of pigment suspended in acrylic polymer emulsion and plasticizers, silicone oils, defoamers, stabilizers, or metal soaps. Most acrylic paints are water-based but become water-resistant when dry.

One of the main color compounds of acrylic paint is titanium dioxide which can be harmful to marine life. Eco-friendly, plant-based acrylic paint containing zero plastic that is 100% titanium-free and marine-friendly is currently under development.

### Penetrating Wood Sealer

A semi-transparent waterproofing stain and sealer enhances a wood veneer's natural pattern while providing increased protection from the elements. They are formulated: (i) to protect the wood veneer from drying out and cracking under direct sunlight (UV Protection), (ii) to ensure that surface water beads on contact and cannot soak into the wood veneer (Water Resistant) and (iii) to withstand changes in environmental conditions having a tough surface finish (Durability Protection).

In general, such penetrating wood sealers are composed of acrylic resin. The resin may be applied to the wood veneer surface by using a pad applicator, brush, nap or sprayer.

### Water-Based Self-Sealer

A water-based self-sealer for wood is a type of wood finish that serves both as a sealer and topcoat in one product. It is designed to seal the wood surface, fill pores, and create a protective layer, all while enhancing the wood's natural beauty. The term “self-sealer” means you don't need a separate sealing product before applying the finish.

Key features of water-based self-sealers include (1) water-based formula-uses water as the primary solvent, making it low in volatile organic compounds (VOCs) and environmentally friendly and dries quickly and cleans up easily with soap and water. (2) dual functionality-acts as both a sealer (to protect and prepare the surface) and a topcoat (to provide durability and a finished look). (3) clarity-often dries clear, preserving the natural color and grain of the wood.

### Lignin

It is one of the three main constituents of wood along with cellulose and hemicellulose. It is the second most abundant biopolymer and most abundant natural aromatic compound. One of its most promising applications is related to the fabrication of thermosetting materials such as phenol/formaldehyde resins, polyurethanes, epoxies, and thiol-ene resins.

### Biodegradable Glues

They are designed to break down naturally over time. These materials are often derived from plant-based sources like corn or soybeans, which are renewable and sustainable. When the glue is applied, it forms a strong bond between two surfaces, just like traditional glue. However, unlike traditional glue, biodegradable glue will break down naturally over time, leaving behind no harmful residue or waste.

Biodegradable adhesives decompose naturally over time into harmless components such as carbon dioxide, water, mineral salts, and microbial biomass.

### Protein Adhesives

Eco-friendly protein adhesives have been around since ancient times, and are commonly used in bookbinding, woodworking, case making, and box-making applications. Protein adhesives are made up of just a few all-natural ingredients, which include gelatin, glycerin, water, Epsom salt and corn sugar.

Since these raw materials are naturally recyclable, protein adhesives are also completely biodegradable. They will begin breaking down only weeks after being recycled back into the natural environment.

### Animal Adhesive Products

Animal glue, also referred to as “hide glue,” was the first kind of binding product known to man. It was the primary type of adhesive or glue available before modern synthetic polymers were discovered.

Animal adhesives are derived from gelatin that is extracted from collagen, a naturally occurring substance found in bovine and porcine hides. As a sizing agent, animal-based adhesive and binding products are water soluble. Until the introduction of synthetic adhesives, animal glue was the preferred gluing agent due to its great versatility and usefulness in various fields of application.

Unlike other types of adhesives, animal glue is applied while hot. Its unique properties as a non-toxic adhesive and glue make animal glue ideal for bookbinding, laminating and woodworking. Animal-based adhesives also dissolve quickly and are safe and biodegradable. Reference is made to: internet.usadhesive.com/animalglue.aspx

### Animal-Based Adhesives

Casein and gelatin are two natural components used to produce animal adhesives. These adhesives are frequently utilized in woodworking. Although they are biodegradable, they are not considered as sustainable as plant-based adhesives, because animals require large swaths of land and have significantly higher water and energy requirements than plants, not to mention the ethics involved with the treatment and living conditions of animals raised in high-throughput settings.

### Gum Rosin

Gum Rosin, also called colophony or Greek pitch, is made from the resin exuded by pine trees and comes in a range of grades, from dark through to superior Window Glass and Water White grades, which are used to make transparent varnish and lacquers for wood.

It is a solid form of resin produced by heating fresh liquid resin to vaporize the volatile liquid terpene components. At room temperature rosin is brittle, but it melts at stove-top temperature. It chiefly consists of various resin acids, especially abietic acid. Reference is made to internet.en.wikipedia.org/wiki/Rosin

### Shape Memory Effect

In use, cards will be subject to bending as a result of deformation forces. Shape memory effect, otherwise known as elastic deformation, can be defined as the ability of a material to retain its original shape and size after deformation, such as upon the application of an external stimulus. Elastic deformation is the deformation that disappears upon the removal of external forces, causing the alteration and the stress associated with it. Elastic deformation is hence reversible and non-permanent. Elastic deformation is best explained by the chemical concept “elasticity”. Elasticity is the ability of a substance to resume the normal state after deformation.

### Tung Oil

Tung oil or China wood oil is a drying oil obtained by pressing the seed from the nut of the tung tree (Vernicia fordii). Tung oil hardens upon exposure to air (through polymerization), and the resulting coating is transparent and has a deep, almost wet look. Used mostly for finishing and protecting wood, after numerous coats, the finish can even look plastic-like. Related drying oils include linseed, safflower, poppy, and soybean oils.

### Colored Wood Veneers

The tinting process to dye wood veneer sheets involves immersing them in a staining solution which penetrates to the core of the veneer. The veneers may be stained in an alcohol system or steeped for a long period in a spirit-based wood dye. With this product the natural tones of wood veneer may be slightly changed. The tinting process impregnates the wood veneer against humidity. The wood veneer may also be impregnated using a chalk paint without the need for extensive priming or sanding. Reference is made to: internet.tsukiita.jp/en/publics/index/107/; internet.cantisa.es/en/product/deep-dyed/and internet.mundyveneer.com/

### Reconstituted Wood Veneers

Technical, or reconstituted, veneers are man-made wood products created by dyeing and laminating thin sheets of fast-growing wood to replicate the appearance of natural wood species. This process results in a consistent, defect-free product with a wide variety of colors and grain patterns that are available in large, uniform sheets. This makes it an eco-friendly, often more affordable alternative to rare or expensive natural veneers.

### Scent of Wood

The smell of birch wood veneer is a complex blend of fresh, woody, and earthy notes, often with hints of sweetness and smokiness, reminiscent of a forest, while maple wood veneer is nearly inconspicuous as it is a low-odor wood, described as slightly sweet or creamy.

The smell of laser-cut wooden cards is a distinct, often strong, burnt, smoky aroma caused by the laser vaporizing the wood fibers and adhesive layers, releasing natural compounds and char residue.

Wooden transaction cards may be infused with an aromatic blend of perfume oils, saturating the wood veneers with various fragrances.

### Self-bonding Wire

Self-bonding enameled wire (SB-wire), also referred to as bondable magnet wire, is film insulated wire which is coated with an additional bonding adhesive.

Reference is made to: internet.elektrisola.com/en/Products/Enamelled-Wire/Types

### SUMMARY

Cards incorporating wood layer(s) are known, such as may be shown in the following patent publications, incorporated by reference herein: WO 96/23276, WO 2022/112610, U.S. Pat. Nos. 8,579,201, 10,572,784, 10,832,115, US 2010/0033297, US 2019/0311238 and US 2022/0184931.

In the stack-up construction of a wooden transaction card or wooden hybrid smartcard, a wood veneer may be accompanied by an overlay protection layer, an inner-ply layer, an adhesive backer, a polyester backer, a melamine backer, a paper backer, a fleece backer (woven or non-woven), a Tyvek backer, a fiberglass backer, a composite veneer backer, or a raw metal layer (stainless steel, copper, aluminum, etc.). Further, the layers may include a pre-applied thermoset or thermoplastic adhesive layer (eco-friendly or biodegradable), in dry film form or as a resin, penetrating the wood fibers during press lamination. Backers and inner-ply layers act as intermediate tear resistant layer to provide strength and protection against veneer cracking, splitting and curling.

It is an object of the invention to compress a stack of wood veneer layers (or “wooden layers”, or “wood layers”), adhesive layers and reinforcement layers in forming a transaction card, which has desirable properties with regard to dimensional stability (e.g. uniform thickness, flatness, shape memory effect, substantially no warpage, low swelling and shrinking when exposed to humidity, moisture and wetness), increased hydrophobicity (e.g. low moisture/water adsorption, increased water-repellency, low wettability), increased hardness and scratch-resistance, and color-stability against ultraviolet (UV) and visible (VIS) light and/or temperature changes.

The method should also allow for producing wood-based transaction cards enabling laser-engraving of graphic features and precise cutting (singulation process) with no incineration, thus allowing for smooth edges as well as precise surface structuration.

An object of the invention is to compress a stack of wood veneer layers and reinforcement layers in forming a transaction card, with integrated components, such as a wire embedded booster antenna circuit inductively coupled or physically connected to an RFID chip or dual interface chip module.

A reinforcement layer (RL) may also be referred to as an adhesive coated substrate layer (ACSL) or an adhesive coated fleece (ACF), comprising a substrate layer (SL) of (wetlaid) nonwoven fabric coated on both sides with an adhesive layer (AL). The wetlaid nonwoven fabric (aka fleece) is processed through a mechanical finishing technique of calendering. The calendered nonwoven fabric having a defined weight, initial thickness, strength, softness and air permeability may be a hydroentangled nonwoven, a glass fiber nonwoven or a hybrid nonwoven of glass fiber and fleece. This calendering process of thinning increases the modulus, strength, tear resistance, puncture resistance and impact strength of the fabric by decreasing its thickness.

According to the invention, generally, a smartcard (SC) which is a wooden transaction card (WTC) comprises several wooden, reinforcement and adhesive layers with an in-card booster antenna circuit incorporated in a core subassembly. A module opening (MO) which may be stepped (having P1 and P2 cross-dimensions) extends into the layers for implanting a chip module for a physical interconnection or inductive coupling. The wooden layers may be sliced or rotary peeled, preconditioned at the mill with a moisture content of 8%, and may be prepressed to regulate the thickness. The reinforcement layers may comprise a substrate layer (SL) of nonwoven fabric and coated on one or both sides with an adhesive layer. A booster antenna may be incorporated in an adhesive layer supported by an underlying substrate layer (SL). The core subassembly (2 or 3-ply wood veneer construction) may be prelaminated to a defined thickness before final lamination of the complete assembly. The final lamination cycle entails a compression process of reducing the stack of wood veneer, reinforcement and adhesive layers to an ISO conforming thickness of 800 μm. The pressure applied ranges between 200 N/cm² and 850 N/cm² at a temperature between 135° C. and 150° C. depending on the thickness and type of wood species in the stack-up assembly (and the number of stacked assemblies in the lamination press). A laser engravable topcoat may comprise a water-based self-sealer or UV varnish protecting underlying artwork.

According to an embodiment of the invention, an adhesive coated substrate layer (ACSL: AL+SL+AL) has multiple purposes: (i) as a reinforcement layer (RL) to improve the structural integrity of the card body; (ii) the adhesive layer (AL) on both sides of the substrate layer (SL) provide for interlayer bonding between overlapping wood veneer layers (WL); and (iii) the adhesive layer (AL) on either side of the substrate layer (SL) provides an elastic deforming medium to facilitate the wire embedding of an antenna structure (AS) in or on the substrate layer (SL).

According to an embodiment of the invention, generally, a wooden transaction card (WTC) or smartcard (SC) comprises several wood veneer layers, reinforcement layers, adhesive layers, and a booster antenna circuit. Module openings extend into said layers for implanting a transponder chip module. The wood veneer layers may be sliced or rotary peeled and may be prepressed. The reinforcement layers may comprise an adhesive coated substrate layer (ACSL) such as a wetlaid non-woven fabric comprising cellulose and synthetic fibers bonded with a latex binder. Alternatively, the substrate layer may comprise pulp and fiber, paper or the like. A laser engravable topcoat may comprise a water-based self-sealer or a UV varnish protecting underlying artwork.

According to an embodiment of the invention, the core subassembly (CS) of a wooden transaction card (WTC) may comprise two layers (upper and lower) of wood veneer (e.g. micro thin rotary peeled wood veneer (RPWV) such as maple or birch with a thickness of 150 μm) sandwiching a substrate layer (SL) of nonwoven fabric (~100 μm (post calendering from an initial thickness of ~220 μm)) coated on both (top and bottom) sides with an adhesive layer (~25 μm) having an overall thickness of 150 μm before press lamination, wherein the top adhesive layer incorporates an antenna structure (AS) such as a wire embedded antenna or antenna circuit (comprising self-bonding insulated copper wire (bare copper wire Ø: 80 μm or 112 μm) having 3-4 turns and occupying (disposed in) an area representing 10 to 15% of the total surface area of the card body (4,621 mm²) and wherein the adhesive, such as a wood glue (PVAc), on both sides of the nonwoven substrate layer functions as a thermoplastic bonding agent in the press lamination process, adhesively attaching the upper and lower wood veneers to the inner substrate of nonwoven fabric in the presence of the antenna structure (AS). See, for example, FIG. 7A.

The substrate layer (SL) may comprise a calendered nonwoven fabric which increases the tensile strength of the substrate layer. Alternatively, instead of calendering, the substrate layer may be laminated with adhesive film.

The adhesive layers (AL) may comprise wood glue, or thermoplastic adhesive, or thermosetting adhesive (B stage for wire embedding).

The post lamination of the core subassembly (CS) with two layers of wood veneer (2-ply construction) may have a thickness of 335 μm±15 μm (26% compression).

The lamination parameters of the 2-ply core subassembly may for example be 15 kg per cm² of pressure at a temperature of 140° C. for a dwell time of 6 minutes. This equates to 147 N/cm² across an area of 360 mm×605 mm, representing 32.7 tons of pressure.

According to an embodiment of the invention, the thickness of the top adhesive layer to accommodate the wire embedded booster antenna may be increased during the substrate coating process from 25 μm to 35 μm or 50 μm (on one or both sides of the substrate), in order to facilitate the embedding process in countersinking the self-bonding wire into the adhesive coated substrate layer with sufficient penetration depth to fix the wire conductor in the adhesive while at the same time enhancing the speed of embedding in forming the antenna structure (AS). Post embedding, the wire antenna structure (AS) scribed into the adhesive layer (AL) may be pre-pressed in a lamination press to ensure proper adhesion of the antenna to the underlying substrate.

According to an embodiment of the invention, the core subassembly (CS) of a wooden transaction card (WTC) may comprise three layers (upper, middle and lower) of wood veneer (e.g. micro thin rotary peeled wood veneer (RPWV) such as maple or birch with a thickness of 150 μm) and two substrate layers of nonwoven fabric (~100 μm (post calendering from an initial thickness of ~220 μm)) coated on both sides with an adhesive layer (~25 μm) having an overall thickness of 150 μm, wherein a first adhesive coated substrate layer (1^{st} ACSL) is arranged between the upper and middle layer of wood veneer (WV or WL) and a second adhesive coated substrate layer (2^{nd} ACSL) is arranged between the middle and lower layer of wood veneer (before press lamination), wherein the top adhesive layer of the first adhesive coated substrate layer (1^{st} ACSL) between the upper and middle layer of wood veneer incorporates an antenna structure (AS) such as a wire embedded antenna circuit (comprising self-bonding insulated copper wire (bare copper Ø 80 μm or 112 μm) having 3-4 turns and occupying an area representing 10 to 15% of the total surface area of the card body (4,621 mm²) and wherein the adhesive, such as a wood glue (PVAc), on both sides of the first adhesive coated substrate layer (1^{st} ACSL) functions as a thermoplastic bonding agent in the press lamination process, adhesively attaching the upper and middle wood veneers to the inner substrate of nonwoven fabric, in the presence of the antenna structure (AS). Alternatively, the antenna structure may be a plated copper antenna. See, for example, FIG. 7B. The thickness of the adhesive layer accommodating the wire embedded booster antenna may be increased from 25 μm to 35 μm or 50 μm to facilitate the wire embedding process.

The post lamination of the core subassembly (CS) with three layers of wood veneer (3-ply construction) may have a thickness of 545 μm±15 μm (27% compression).

The core subassembly having a 2- or 3-ply construction may be further laminated between two layers (front and rear) of rotary peeled wood veneer or sliced wood veneer using two reinforcement layers of adhesive coated fleece (ACF) to complete the stack-up construction of the card body. The lamination parameters, compressing the layers together, determines the thickness of the laminated assembly.

According to an embodiment of the invention, the exposed outer layers of wood veneer (front and rear layers of rotary peeled or sliced wood veneer) may be impregnated with a substance such resin, lacquer or enamel before press lamination, wherein the substance during press lamination seals the pores of the wood veneer. Alternatively, the substance may be applied thereto post lamination of the assembly.

According to an embodiment of the invention, a sacrificial layer such as a release film, placed between the lamination plates and the wood veneer assembly (including reinforcement layers) for compression in a lamination press, may be coated with a primer to promote adhesion of digital ink, with a sealant for impregnation (water proofing), with a colorant for staining, with a resin for robustness or with a polymer to create a very smooth surface (plasticizing). Post lamination of the assembly, the surface finish of the exposed outer layers of wood veneer may be changed in terms of texture (touch and feel), color and strength.

According to an embodiment of the invention, a white channel (undercoat) may be applied to the wood veneer surface to enhance the color of the digitally deposited CYMK ink (over-print) followed by a topcoat of matt varnish.

According to an embodiment of the invention, in using preconditioned wood veneers from the mill with a moisture content in the range of 6 to 9% and pre-laminating the core subassembly before final lamination, the teachings of US 2024/0001585 do not apply (may be circumvented by some embodiments disclosed herein).
Firstly, a pre-conditioning cycle (to remove moisture at a temperature of 50-100° C. and a pressure of 0 to 2 MPa (0-200 N/cm²)) is not required; and
Secondly, a (very high) densification pressure of 9-50 MPa (900-5000 N/cm²) is not required to compress the stack-up assembly of wood veneers and adhesive coated substrate layers (ACSL) to ISO thickness as disclosed in FIGS. 7C and 7D.

According to an embodiment of the invention, passive (dual interface) wooden transaction cards (WTC) or smartcards (SC) may comprise a combination of sliced wood layers (SWL: 525 μm) and micro-thin (rotary) peeled wood layers (PWL: 150 μm) with interlayers of a substrate layer (SL) coated on one or both sides with an adhesive layer (AL) to function as a bonding layer (BL) and reinforcement layer (RL) with the substrate layer (SL) comprising nonwoven fabric, pulp and fiber, paper or the like. The wood layers may be stained for color and impregnated for waterproofing. The sliced wood layers (SWL) may be strips of maple veneer adhesively joined together (splicing) to form a sheet, while the rotary peeled wood layers are cut as a continuous web and reduced to sheets. The sliced wood layers (SWL) may be compressed to 50% of their original thickness in a prepress process, before final lamination of the complete stack-up assembly.

Alternatively, the complete stack-up may be laminated in a single process step using a pressure between 200 N/cm² and 850 N/cm² at a temperature between 135° C. and 150° C. for a dwell time between 30 and 50 minutes followed by a cooling cycle to ambient pressure and temperature, depending on the type and thickness of wood species in the stack-up construction of the assembly (and the number of stacked assemblies in the lamination press).

A booster antenna (BA) in the form of a wire embedded antenna may be ultrasonically scribed into an adhesive coated substrate layer (ACSL) functioning as a bonding layer (BL) and reinforcement layer (RL) and sandwiched between upper and lower intermediate wood layers (IWL or PWL) of micro-thin (rotary peeled) wood veneer forming a core subassembly (CS) as shown in FIG. 7A.

Wooden transaction cards may further comprise a water-based self-sealer or a UV varnish as a topcoat, to protect underlying artwork (laser etched features or digitally deposited ink) and which may be laser marked with personalization data. The cards may be provided with a laser engraved QR code. See, for example, FIG. 7C.

According to an embodiment of the invention, the front and rear sliced wood veneer layers (WL, SWL) each with a thickness of 525 μm sandwiching a core subassembly (CS) of rotary peeled wood veneers (2-ply construction) allows for increased card body weight when compressed to an ISO conforming thickness of 800 μm.

According to an embodiment of the invention, the booster antenna (BA) or booster antenna circuit (BAC) shown in FIG. 7C is presented as a round wire embedded into the adhesive layer (AL) of the underlying substrate (SL). Optionally, the wire conductor may be embedded into an adhesive layer (AL) applied to an underlying wood layer (WL or PWL).

The wooden transaction cards (WTC) may also comprise a decorative (enlarged) transponder chip module (TCM) with a contact and contactless interface, without the necessity for an in-card booster antenna circuit (BAC) or coupling frame (CF).

The wooden transaction cards (WTC) may comprise a printed antenna circuit (PAC) for amplification of the RF field, accomplished by the digital deposition of conductive ink.

According to an embodiment of the invention, to avoid card warpage post lamination of the stack-up assembly, the wood veneers may receive micro-slits along the grain direction before lamination, allowing the adhesive to seep through the micro-slits during press lamination with the objective to stabilize the card body construction after singulation and to achieve absolute flatness of the card body.

According to an embodiment of the invention, passive dual interface wooden transaction cards (WTC) or smartcards (SC) may comprise 5 layers of micro-thin (rotary) peeled wood layers (PWL: 150 μm) with 4 interlayers of a substrate layer (SL) coated on both sides with an adhesive layer (AL) to function as a bonding layer (BL) and reinforcement layer (RL) with the substrate layer (SL) comprising nonwoven fabric, pulp and fiber, paper or the like. The core subassembly (CS) comprises 3 layers of rotary peeled wood veneer (PWL) prelaminated with two adhesive coated substrate layers (ACSL) as shown in FIG. 7B. In the final lamination step, the front and rear rotary peeled wood veneers are laminated via adhesive coated substrate layers to the core subassembly (CS). A booster antenna (BA) in the form of a wire embedded antenna may be ultrasonically scribed into an adhesive coated substrate layer (ACSL) of the core subassembly (CS) functioning also as a bonding layer (BL) and reinforcement layer and sandwiched between the upper and middle intermediate wood layers (IWL or PWL) of micro-thin (rotary peeled) wood veneer forming a core subassembly (CS) as shown in FIG. 7B. Wooden transaction cards may further comprise a water-based self-sealer or a UV varnish as a topcoat, to protect underlying artwork (laser etched features or digitally deposited ink) and which may be laser marked with personalization data. The cards may be provided with a laser engraved QR code. See, for example, FIG. 7D.

According to an embodiment of the invention, each substrate layer (SL) in FIGS. 7C and 7D has an orientation and is positioned crosswise or lengthwise to the grain direction of each wood veneer layer (WL).

According to an embodiment of the invention, preconditioning rotary peeled or sliced wood veneers with a moisture content in the range of 6% to 9% is performed (dried) at the mill.

According to an embodiment of the invention, a laminated sheet assembly (LSA), a stack-up construction, having a plurality of card body sites for production of a like plurality of smart cards (SC), said laminated sheet assembly (LSA) having a front (top) exposed surface and a rear (bottom) exposed surface, and said laminated sheet assembly (LSA) having a core subassembly (CS) comprising (pre-conditioned) two or three layers of micro thin rotary peeled wood veneer layers (WL, PWL) with each wood layer (WL) having a thickness of 150 μm sandwiching an adhesive coated substrate layer (AL(~25 μm)+SL (~100 μm (post calendering from an initial thickness of ~220 μm))+AL (~25 μm)=ACSL) with a thickness of 150 μm comprising a substrate layer (SL) of wetlaid nonwoven fabric (cellulose and synthetic fibers bonded with a latex binder) coated on both sides (top and bottom) with a thermoplastic (PVAc) adhesive layer (AL), wherein a booster antenna (BA) or booster antenna circuit (BAC) is incorporated into the top adhesive layer (AL) of said adhesive coated substrate layer (ACSL);

Optionally pre-laminating the core subassembly (CS), a 2 or 3-ply subassembly sandwiching a booster antenna circuit (BAC) integrated into an adhesive layer (AL) of the adhesive coated substrate layer (ACSL) at a lamination pressure in the range of 150-200 N/cm² and at a temperature of 140° C. for a dwell time of 6 minutes; said laminated sheet assembly (LSA) produced by forming a final stack-up assembly of (preconditioned) outer (exposed) layers (front and rear) of wood veneer, rotary peeled (WL, PWL with a thickness of 150 μm) or sliced (WL, SWL with a thickness of 525 μm), with said wood layers (WL) having a moisture content in the range of 6% to 9%, and the stack-up assembly further having inner intermediate layers (top and bottom) of adhesive coated substrate layers (ACSL) with each ACSL layer having a thickness of 150 μm sandwiching the core subassembly (CS); laminating the complete stack-up assembly (front WL+top ACSL+CS (2 or 3 ply construction with integrated BAC)+bottom ACSL+rear WL) in a single step using a pressure between 200 N/cm² and 850 N/cm² at a temperature between 135° C. and 150° C. for a dwell time between 30 and 50 minutes followed by a cooling cycle to ambient pressure and temperature, in compressing the final stack-up assembly to an ISO conforming thickness of 800 μm; and post lamination of the complete assembly, coating the exposed surfaces with a primer for the purpose of impregnation (waterproofing) and surface treatment (adhesion promoter).

According to an embodiment of the invention, a highly compressed laminated sheet assembly (LSA) of multiple wood veneer layers (e.g. 5 layers), adhesive coated substrate layers (ACSL) as interlayers (e.g. 4 layers) for bonding and reinforcement, an array of card body sites in a production format (e.g. 3×8 (24-up), 5×5 (25-up), 6×8 (48-up), etc.) incorporating a booster antenna circuit (BAC) at each card body position, and the sheet assembly having a top and bottom exposed surface (front and rear face) coated with a primer (post lamination) for impregnation (waterproofing) and surface treatment (adhesion promoter) to receive the later deposition of digital ink.

The wood veneer layers (WL) may be colored or non-colored micro thin rotary peeled wood veneer (PWL e.g. birch) each having a thickness of 150 μm (preconditioned (drying process) at the mill with a moisture content in the range of 6 to 9 percent) and the adhesive coated substrate layers (ACSL) each having a thickness of 150 μm comprising a wetlaid nonwoven fabric (~ 100 μm (post calendering from an initial thickness of ~220 μm)) coated on both sides with a thermoplastic adhesive (~25 μm) such as PVAc with the nonwoven comprising cellulose and synthetic fibers (e.g. polyester fibers) bonded with a latex binder.

The array of booster antennas (BA) or booster antenna circuits (BAC) may be formed by wire embedding into an adhesive coated substrate layer (ACSL) using multiple ultrasonic tools (aka sonotrodes). Said adhesive coated substrate layer (ACSL) incorporating the array of booster antenna circuits (BAC) may be laminated between layers of wood veneer to form a core subassembly (CS: 3-ply construction) before final lamination of the complete stack-up. The total thickness of the individual layers forming the assembly (5 wood veneer layers and 4 adhesive coated substrate layers) before press lamination may be approximately 1350 μm (such as 1300-1400 μm).

The post lamination thickness of the laminated sheet assembly (LSA) may be approximately 800 μm, representing a shrinkage of approximately 40%. The post laminated assembly may be a solid homogenous sheet which cannot be delaminated to reveal individual layers, achieved through the composition of material layers of micro thin wood veneer (e.g. 5 layers), (wetlaid) nonwoven fabric (e.g. 4 substrate layers (SL) for reinforcement) and adhesive (e.g. 8 coating layers) forming the stack-up and the compression process of laminating in multiple steps with defined lamination parameters. The lamination parameters of the 3-ply core subassembly may for example be 15 kg per cm² of pressure at a temperature of 140° C. for a dwell time of 6 minutes. This equates to 147 N/cm² across an area of 360 mm×605 mm (e.g. 3×8 format), representing 32.7 tons of pressure. The final lamination step of the complete stack-up may be a single continuous lamination process (linear, gradual (curved) or exponential) using a pressure between 200 N/cm² and 850 N/cm² at a temperature between 135° C. and 150° C. for a dwell time between 30 and 50 minutes followed by a cooling cycle to ambient pressure and temperature, depending on the type and thickness of wood species in the stack-up construction of the assembly (and the number of stacked assemblies in the lamination press).

Post lamination, the laminated sheet assembly (LSA) may receive magnetic stripes (MS). Post lamination, the laminated sheet assembly (LSA) may also receive a milled-out pocket (stepped recess (P1 and P2) to accept the later implanting of a chip module (CM)) at each card body site in the array, simplifying the production at the smartcard manufacturer. The milled-out pocket may have a surface roughness (Ra) of approximately 6 μm. Index holes and or fiducials may be provided for later alignment of the laminated sheet assembly (LSA). In reducing the laminated sheet assembly (LSA) to card bodies (singulation process), the sheets may be CO₂ laser cut, punched or CNC milled. The resultant card bodies are completely flat (without warpage) with a defined stiffness, breakage point and a weight of approximately 4 grams. See, for example, FIG. 7E.

According to an embodiment of the invention, the substate layer(s) (SL) may be colored (dyed or stained) or non-colored, and the adhesive coating layer(s) (AL) may be colored (pigmented) or non-colored. To create contrast, some of the inner or outer wood layers (WL) may be colored or non-colored. The melting of the adhesive layers (AL) during the press lamination process may further contribute to an unique color change.

The 5-ply stack-up construction in FIG. 7E may be modified to enhance the robustness and stiffness of the card body structure by replacing the reinforcement layers (adhesive coated substrate layers of nonwoven fabric) with a glass fiber nonwoven fabric. The assembly may comprise five layers of wood veneer and three 3 layers of glass fiber nonwoven fabric coated on both sides with an adhesive for interlayer bonding and one layer of a (wetlaid) nonwoven fabric coated on both sides with a thermoplastic adhesive to incorporate a booster antenna circuit.

To increase the weight of the individual card bodies (CB), the stack-up construction may be modified to a 4-ply construction. The stack-up assembly may comprise two layers (front and rear) of sliced wood veneer (WL, SWL e.g. maple) with each wood layer (WL) having an initial thickness of approximately 525 μm and two layers of micro thin rotary peeled wood veneer (WL, PWL) with an initial thickness of 150 μm and three adhesive coated substrate layers (ACSL) as interlayers for bonding and reinforcement with an initial thickness of 150 μm. The total thickness of the assembly before lamination may be 1800 μm. The post lamination thickness of the assembly may be approximately 800 μm, representing a shrinkage of approximately 55%. The central adhesive coated substrate layer (ACSL) incorporating the array of booster antenna circuits (BAC) may be laminated between the two layers (upper and lower) of rotating peeled wood veneer (WL, PWL) to form a core subassembly (2-ply construction) before final lamination of the complete stack-up. See, for example, FIG. 7F.

According to an embodiment of the invention, a wooden transaction card (WTC) or smartcard (SC) comprises an odd number of wooden layers (WL) such as 5 and an even number of adhesive coated substrate layers (ACSL) such as 4; wherein the wooden layers (WL) comprise micro thin rotary peeled wood veneer with a grain direction (crosswise or lengthwise) having a thickness between 125 and 150 μm; wherein the substrate layers comprise nonwoven fabric (fleece) laid in a specific direction and coated on both sides with an adhesive having a total thickness of 150 μm, to function as bonding and reinforcement layers (RL); wherein the individual wooden layers and adhesive coated substrate layers (ACSL) are oriented differently (such as 90 degrees) with respect to each other; wherein the complete stack-up construction of wooden layers (WL: 5×150 μm) and adhesive coated substrate layers (ACSL: 4×150 μm) with a total thickness of 1350 μm (such as 1300-1400 μm) are laminated in one step to produce a multi-layered laminate with a thickness of ~875 μm representing a shrinkage in thickness of approximately 35%, with the adhesive from the substrate layers penetrating the pores of the wooden veneer layers for the purpose of adhesion, reinforcement and impregnation; wherein the outer wooden layers of the card body structure (post lamination) may be sanded back to be ISO thickness compliant; wherein the sanded-back laminate may be impregnated with a water based self-sealer or primer for the purpose of waterproofing and as an adhesion promoter for the deposition of digital ink; wherein the water-protected sanded-back laminate may receive graphic features by way of digital inkjet printing or laser etching; and wherein the graphic features are protected by a topcoat (film, resin or varnish) which may be laser engravable. The water-protected sanded-back laminate with graphic features may be reduced to card bodies (singulation process) by CO₂ laser cutting while at the same time sealing the perimeter edges of the individual card bodies to protect against the environment. A wire embedded booster antenna circuit (BAC) may be incorporated into an adhesive coated substrate layer (ACSL) forming the core subassembly (CS), and optionally shrouded with an adhesive layer or primer to enhance the interlayer adhesion. See, for example, FIG. 8.

According to an embodiment of the invention, an adhesive coated substrate layer (ACSL) may replace the application of spray coating an impregnation layer (IL) and instead laminating the ACSL to the exposed wood veneer layers (front and rear surfaces) in the lamination of the complete assembly. The (single or double sided) adhesive coating and the substrate layer are entirely absorbed, during the lamination compression process, into the exposed wood veneer(s). The resulting waterproof surface is also an adhesion promoter for the deposition of digital ink.

According to an embodiment of the invention, the substrate layer for reinforcement may comprise a nonwoven fabric (fleece), a hybrid construction of nonwoven and fiberglass or a hydroentangled nonwoven.

In their various embodiments, the invention(s) described herein may relate to industrial and commercial industries, such RFID applications, payment smartcards, electronic credentials, identity cards, loyalty cards, access control cards, key-cards, biometric cards, and the like.

The invention(s) described herein may relate to innovations in or improvements to RFID enabled, wood-containing transaction cards, and may also relate to methods of improving the environment by encouraging users to plant trees (or the like) or causing trees (or the like) to be planted, thereby reducing carbon content in the atmosphere.

Other objects, features and advantages of the invention(s) disclosed herein may become apparent in light of the following illustrations and descriptions thereof.

### BRIEF DESCRIPTION OF THE DRAWINGS

Reference will be made in detail to embodiments of the disclosure, non-limiting examples of which may be illustrated in the accompanying drawing figures (FIGS.). The figures may generally be in the form of diagrams. Some elements in the figures may be stylized, simplified or exaggerated, others may be omitted, for illustrative clarity.

Although the invention is generally described in the context of various exemplary embodiments, it should be understood that it is not intended to limit the invention to these particular embodiments, and individual features of various embodiments may be combined with one another. Any text (legends, notes, reference numerals and the like) appearing on the drawings are incorporated by reference herein.

Some elements and (sub) assemblies may be referred to with letters (“CB”, “CBS”, “CS”, “FS”, “MO”, MS″, “RL”, “RS”, “SC”, “TCM”, “WL”, etc.) rather than or in addition to numerals. Some similar (including substantially identical) elements in various embodiments may be similarly numbered, with a given numeral such as “310”, followed by different letters such as “A”, “B”, “C”, or “a”, “b”, “c”, etc. (resulting in “310A”, “310B”, “310C” or “310a”, “310b”, “310c”), and may collectively be referred to simply by their common numeral (“310”).

FIG. 1 (compare FIG. 1 of US 2024/0001585) is a laminated structure consisting of four rectangular layers of densified wood veneer whereby adjacent layers have different wood grain directions, according to the prior art;

FIG. 2 (compare FIG. 3 of US 2024/0001585) is a partial view of the cross-section of a card, according to the prior art;

FIG. 3 (compare FIG. 4 of US 2024/0001585) is an exploded assembly drawing of a card with electronic functionality, according to the prior art;

FIG. 4 (compare FIG. 5 of US 2024/0001585) is a perspective view of a card with electronic functionality, according to the prior art;

FIG. 5 (compare FIG. 1 of US 2022/0184931) is a perspective view showing a wooden card, according to the prior art; and

FIG. 6 (compare FIG. 11 of U.S. Pat. No. 10,832,115) is a schematic diagram depicting a wood-on-wood inlay, according to the prior art.

FIG. 7A is an exploded perspective view of a 2-ply core subassembly (CS) of a wooden transaction card (WTC) comprising upper and lower wood layers (WL) sandwiching a substrate layer (SL) of nonwoven fabric coated on both sides with an adhesive layer (AL) to function as a bonding layer (BL) and reinforcement layer (RL) wherein a booster antenna (BA) is embedded into the top adhesive layer (AL) of said adhesive coated substrate layer (ACSL), according to an embodiment of the invention.

FIG. 7B is an exploded perspective view of a 3-ply core subassembly (CS) of a wooden transaction card (WTC) comprising upper and middle wood layers (WL) sandwiching a substrate layer (SL) of nonwoven fabric coated on both sides with an adhesive layer (AL) with a booster antenna (BA) incorporated into the top adhesive layer of said adhesive coated substrate layer (ACSL) as presented in FIG. 7A, and further comprising a lower wood layer (WL) with an adhesive coated substrate layer (ACSL) assembled between the middle and lower wood layers, according to an embodiment of the invention.

FIG. 7C is an exploded perspective view of a construction of a 4-ply wooden card having layers of wood veneer (sliced and rotary peeled), adhesive coated substrate layers for reinforcement and bonding, and a wire embedded booster antenna (BA) incorporated in an adhesive coated substrate layer (ACSL), according to an embodiment of the invention. A transponder chip module (TCM) is shown in this figure, and may be omitted in some of the following figures, for illustrative clarity.

FIG. 7D is an exploded perspective view of a construction of a 5-ply card body (CB) for a wooden transaction card (WTC) having layers of rotary peeled wood veneer (PWL), adhesive coated substrate layers for reinforcement and bonding, and an embedded wire booster antenna (BA) incorporated in an adhesive coated substrate layer (ACSL), according to an embodiment of the invention.

FIG. 7E is an exploded perspective view of a laminated sheet assembly (stack-up, construction) in a 5×5 format having a plurality of card body sites (SCB) for production of a like plurality of smart cards (wooden transaction cards (WTC)), said laminated sheet having a front (top) exposed surface and a rear (bottom) exposed surface, said laminated sheet assembly comprising 5 wood veneer layers and 4 adhesive coated substrate layers, according to an embodiment of the invention.

FIG. 7F is an exploded perspective view of a laminated sheet assembly (stack-up, construction) in a 3×8 format having a plurality of card body sites (SCB) for production of a like plurality of smart cards (wooden transaction cards (WTC)), said laminated sheet having a front (top) exposed surface and a rear (bottom) exposed surface, said laminated sheet assembly comprising 4 wood veneer layers (WL) and 3 adhesive coated substrate layers (ACSL), according to an embodiment of the invention.

FIG. 8 is an exploded perspective view of a construction of a 5-ply wooden transaction card (WTC) having a booster antenna (BA) incorporated into an adhesive coated substrate layer (ACSL), according to an embodiment of the invention.

FIG. 9A is a diagram of a wire embedded booster antenna for a smartcard having landing pads for a galvanic interconnection to a chip module, according to an embodiment of the invention.

FIG. 9B is a diagram of a wire embedded booster antenna (BA) for a smartcard having a coupler coil (CC) for inductive coupling with the module antenna (MA, not shown) of a transponder chip module (TCM, not shown), according to an embodiment of the invention.

FIGS. 10A, 10B and 10C are cross-sectional views illustrating embedding coated wire (CW) for a booster antenna (BA) in an adhesive layer (AL) on a support layer (SL), according to an embodiment of the invention.

### GLOSSARY

The following abbreviations may appear in the drawings and in the description that follows:

| | | | |
|---|---|---|---|
| LSA | laminated sheet assembly | FL | fleece layer |
| SC | smartcard | PL | paper layer |
| WTC | wooden transaction card | ACF | adhesive coated fleece |
| SCB | card body site | ACP | adhesive coated paper |
| TCM | transponder chip module | ACW | adhesive coated wood |
| CP | contact pads | CBS | card body subassembly |
| CB | card body | FS | front subassembly |
| MA | module antenna | CS | core subassembly |
| MO | module opening | RS | rear subassembly |
| RF | radio frequency | AFL | additional front layers |
| SFL | sacrificial layer | ARL | additional rear layers |
| PWL | peeled wood (or wooden) layer | AS | Antenna structure |
| SWL | sliced wood (or wooden) layer | BA | booster antenna |
| IWL | intermediate wood (or wooden) | | (or booster |
| | layer | | antenna circuit |
| WL | wood (or wooden) layer | | (BAC)) |
| WV | wood veneer | CF | coupling frame |
| RL | reinforcement (or reinforcing) | PAC | printed antenna circuit |
| | layer | IL | impregnation layer |
| SL | substrate layer | PR | primer |
| AC | adhesive coating | AW | artwork |
| AL | adhesive layer | TC | topcoat |
| ACSL | adhesive coated substrate layer | LM | laser marking |
| AFT | adhesive film transfer | MS | magnetic stripe |
| BL | bonding layer | H | hologram |
| CE | cellulose | HF | holographic foil |
| SF | synthetic fibers | MC | moisture content |
| LB | latex binder | | |

### DESCRIPTION

Various embodiments (or examples) may be described to illustrate teachings of the invention(s), and should be construed as illustrative rather than limiting. It should be understood that it is not intended to limit the invention(s) to these particular embodiments. It should be understood that some individual features of various embodiments may be combined in different ways than shown, with one another. Reference herein to “one embodiment”, “an embodiment”, or similar formulations, may mean that a particular feature, structure, operation, or characteristic described in connection with the embodiment is included in at least one embodiment of the present invention. Some embodiments may not be explicitly designated as such (“an embodiment”).

The embodiments and aspects thereof may be described and illustrated in conjunction with systems, devices and methods which are meant to be exemplary and illustrative, not limiting in scope. Specific configurations and details may be set forth in order to provide an understanding of the invention(s). However, it should be apparent to one skilled in the art that the invention(s) may be practiced without some of the specific details being presented herein.

Furthermore, some well-known steps or components may be described only generally, or even omitted, for the sake of illustrative clarity. Elements referred to in the singular (e.g., “a widget”) may be interpreted to include the possibility of plural instances of the element (e.g., “at least one widget”), unless explicitly otherwise stated (e.g., “one and only one widget”).

In the following descriptions, some specific details may be set forth in order to provide an understanding of the invention(s) disclosed herein. It should be apparent to those skilled in the art that these invention(s) may be practiced without these specific details. Any dimensions and materials or processes set forth herein should be considered to be approximate and exemplary, unless otherwise indicated. Headings (typically underlined) may be provided as an aid to the reader, and should not be construed as limiting.

Reference may be made to disclosures of prior patents, publications and applications. Some text and drawings from those sources may be presented herein, but may be modified, edited or commented to blend more smoothly with the disclosure of the present application.

Cards incorporating transponder chip modules (TCM) are known, such as may be shown in the following patents and patent publications, incorporated by reference herein: U.S. Pat. Nos. 9,272,370; 9,390,364; 9,489,613; and US 2013/0126622.

Reference(s) may be made to links for some websites on the world wide web. The standard (“https” . . . , sometimes including “www”) prefixes may be omitted, or replaced by “internet”.

Cards incorporating wood veneer layers are known, such as may be shown in the following patents and patent publications, incorporated by reference herein: U.S. Pat. Nos. 8,579,201; 10,572,784; 10,832,115; US 2010/0033297; US 2019/0311238; US 2022/0184931; WO 96/23276; and WO 2022/112610.

As used herein, a wooden transaction card (WTC) is a type of smart card (SC) which comprises one or more wood (or wooden) layers (WL) which may be wooden veneer layers. In some embodiments, a booster antenna (BA) may be incorporated into the construction, typically in an adhesive layer (AL) of a reinforcing layer (RL) which may comprise a substrate (or support) layer (SL) having an adhesive layer on at least one side thereof.

Embodiments of wooden transaction cards (WTC) disclosed herein generally comprise card bodies (CB) having several wooden (veneer) layers (WL) which are stacked up and laminated together with adhesive layers (AL) disposed between adjacent ones of the wooden layers. Some of the wooden layers may be sliced wooden layers (SWL), some of the wooden layers may be peeled wooden layers (PWL). Adhesive-coated substrate layers (ACSL) may be included in the stack-up, and may comprise a reinforcement layer (RL) which is a substrate layer (SL) having adhesive layers (AL) or coatings disposed on both sides thereof. A wire antenna structure (AS) functioning as a booster antenna (BA) may be embedded into one of the adhesive layers on the substrate layer. In the exploded views of embodiments of the invention, front (top) surfaces of the various layers are oriented towards the top of the page (sheet), and rear (bottom) surfaces of the various layers are oriented towards the bottom of the page (sheet).

The adhesive coated substrate layer (ACSL=AL+SL+AL) may also be referred to as an adhesive coated fleece (ACF), or simply a reinforcement layer (RL) comprising a substrate layer (SL) of nonwoven fabric comprising cellulose (CE), synthetic fibers (SF) bonded with a latex binder (LB) coated on one or both sides with an adhesive layer (AL).

The substrate layer (SL) for reinforcement may comprise a nonwoven fabric (fleece), a hybrid construction of nonwoven and fiberglass or a hydroentangled nonwoven. Alternatively, the substrate layer may be paper and coated with adhesive, referred to as adhesive coated paper (ACP).

As used herein, the terms “front” and “rear” may appear in some of the figures, and refer to the top (or front face) and bottom (or rear face), as viewed in the figures, of the resulting smart card (SC) which may be a wooden transaction card (WTC) or variation thereof (such as a hybrid metal wood transaction card), or the like.

Terms such as “front”, “top”, “frontmost”, “topmost” and the like may be used to distinguish similar (such as wooden) layers from one another in descriptions of the constructions presented herein. Similarly, terms such as “rear”, “bottom”, and the like may be used to distinguish similar (such as reinforcement) layers from one another. Also, it should be understood that the layers described herein are generally planar, having length and width dimensions substantially equal to the overall dimensions of the card body (CB), the ISO standard for which is 85.60 mm width (long dimension), 53.98 mm height (short dimension). References may be made to front (or top) surfaces (or sides) of layers (such as WL, RL, SL, AL, ML, DMC, CML) consistent with how these surfaces appear in relevant figures. The ISO standard for card thickness is 0.76 mm (760 μm) thick. The individual layers typically have thicknesses which are a fraction of that, such as approximately 100 μm.

It should be understood that all dimensions (such as thickness and weight) and process parameters (such as pressure, temperature and dwell time) may be considered to be approximate (may include dimensions and parameters ranging+/−5 or 10% from a stated “nominal” value), unless indicated otherwise. Sometimes, ranges may be specified, such as (for example):

The thickness of the wooden (veneer) layers (WL, PWL, SWL) having a nominal preconditioned (drying process at the mill) thickness of 150 μm may be between 125 μm and 175 μm.
The thickness of the wooden (veneer) layers WL, SWL) having a nominal preconditioned (drying process at the mill) thickness of 550 μm may be between 525 μm and 575 μm.
The thickness of the adhesive layers (AL), nominally 25 μm, may range from 20-30 μm, prior to lamination.
Prior to calendering, the substrate layer (SL) may have an initial thickness, nominally 220, of 210-230 μm
After calendering, the substrate layer (SL) may have a thickness, nominally 100, of 90-110 μm.
The thickness of a stack-up of layers, before press lamination, nominally 1350 μm, may range from 1300-1400 μm.
The thickness of a stack-up of layers, before press lamination, nominally 1700 μm, may range from 1650-1750 μm.
The thickness of a card body subassembly, before press lamination, nominally 1650 μm, may range from 1600-1700 μm.
A lamination pressure applied to the stack-up, nominally of 500 N/cm², may range from 450-550 N/cm²
A lamination pressure applied to the stack-up, nominally of 850 N/cm², may range from 825-875 N/cm².
A lamination pressure applied to the stack-up, nominally of 900 N/cm², may range from 850-950 N/cm²
Laminating may be performed at a pressure of 150 to 300 N/cm² (nominally 200 N/cm²), at a temperature of 135 to 150° C. (nominally 140° C.), for a dwell time of 6 to 10 minutes.
A lamination pressure applied to the stack-up, nominally 1250 N/cm², may be between 1200 to 1300 N/cm²
After press lamination, the thickness of the card body (CB), nominally 800 μm, may range from 760-800 μm, after lamination.

US 2024/0001585 (4 Jan. 2024; Swiss Wood Solutions; Chanana et al.), entitled “Densified hygroscopic materials and products made thereof”, incorporated by reference herein, discloses a method for densifying a hygroscopic material. The method is for hygroscopic material which may be a natural hygroscopic material or wood. The method comprises the steps of providing the hygroscopic material to be densified; pre-conditioning of the hygroscopic material by adjusting the moisture content of the hygroscopic material to a value within a predefined moisture range, if required; simultaneously heating and pressing the gas-tight packed hygroscopic material under predefined temperature and pressure conditions, whereby the moisture content of the hygroscopic material is kept constant; and obtaining a densified material.

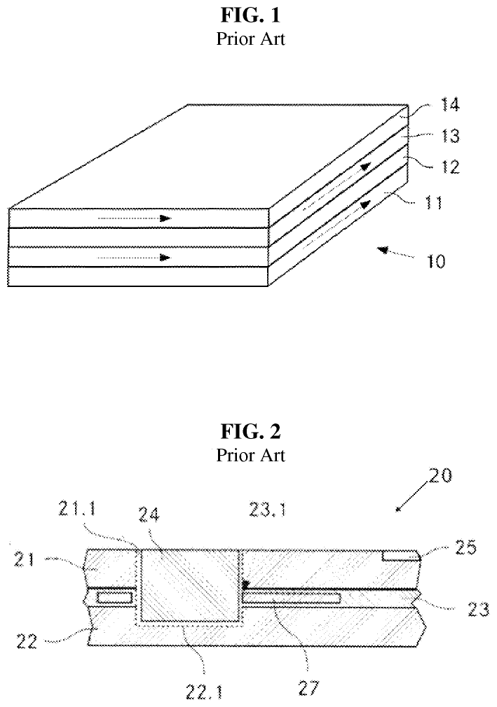

FIG. 1 shows a laminated structure 10 which was produced by laminating four rectangular layers of densified wood veneer 11, 12, 13, 14. The structure was formed by bonding adjacent layers 11, 12, 13, 14 together with an adhesive, e.g. a polyurethane or any other adhesive.

As indicated by the arrows in FIG. 1, the wood grain direction of adjacent layers are perpendicular to each other. This gives a highly stable laminated structure with reduced flexibility. A wooden electronic card 20 as shown in FIG. 1 and having a size of 85.5 mm×54 mm×0.8 mm was produced by according to the following process:

An upper layer 21 (frontside of the card) and a lower layer 22 (backside of the card) each consisting of a densified wood veneer were provided and cut to a size of about 90 mm×60 mm with a computerized numerical control laser engraving and cutting machine (CNCL).

A middle layer 23 consisting of a support sheet (densified veneer) with an integrated/glued electromagnetic coil 27 was provided and cut to the same size as the upper and lower layers 21, 22.

In the upper layer 21 and the middle layer 23, using the CNCL, a rectangular opening 21.1, 23.1 for an integrated circuit chip 24 with electrical surface contacts 24.1 was cut. In the lower layer 22, a rectangular recess 22.1 (deepness of approximately 0.1 mm) was engraved to provide additional place for the chip 24.

A polyurethane foil or gelatin/protein-glue sheet (40-80 g/m²; area density depending on type of wood) was applied on the inside of the upper layer 21 and the lower layer 22 as an adhesive foil. Each layer 21, 22, 23 as well as the chip 24 were carefully positioned and assembled to obtain the basic structure of the card 20. The assembled basic structure was then placed in a vacuum bag, which was then evacuated in order to apply a pressure of approximately 1 MPa. The vacuum was maintained for 6 hours.

The electronic functionality, e.g. a contactless payment function, of the card was tested before the outer surface of the upper layer 21 was engraved using the CNCL. Thereby, a first engraving 25 consisting of a logo and a second engraving 26 consisting of characters and numbers were produced. Thereby, the moving speed and laser power were adjusted in order to avoid burning of the wooden surface. Further engravings were provided on the outer surface of the lower layer 22.

Thereafter, the final shape of the card was cut using the CNCL (using a different set of moving speed and laser power). Subsequently, the engravings 25, 26 were colored using a silver color pen. The drying time was about 2 hours. Then the front side 21 as well as the backside 22 of the card 20 were sanded and polished with by using sanding papers with gradually increasing fineness (180, 240, 320 and 600 grit size). After testing the card functionality, e.g. contactless and contact payment function, the card was ready for use.

The US application 2024/0001585 (Swiss Wood Solutions) is based on the following two previously filed European applications.
PCT/EP2021/083617 filed 30 Nov. 2021, published as WO2022112610 2 Jun. 2022
PCT/EP2020/083947 filed 30 Nov. 2020, published as WO2022111835 2 Jun. 2022

References cited by the PCT against Swiss Wood Solutions' PCT application(s):

| | | |
|---|---|---|
| JP 3136048 B2 | 2001 Feb. 19 | Eidai Co Ltd |

F. Eng et al., “Possibility of Improving the Properties of Mahang Wood Through Phenolic
Compreg Technique” 2014 Feb. 1

| | | |
|---|---|---|
| CN 108582377 | 2018 Sep. 28 | Univ South China Agricult |
| CA 2103882 | 1995 Feb. 12 | Prihoda |
| US 2016/0193868 | 2016 Jul. 7 | Espe |
| CN 111185977 | 2020 May 22 | Zhejiang Academy Forestry |
| U.S. Pat. No. 10,572,784 | 2020 Feb. 25 | Kushner |
| CN 107614221 | 2018 Jan. 19 | Palmholz Co Ltd |
| CN 108773237 | 2018 Nov. 9 | Dongguan Wantusiriu |
| US 2010/033297 | 2010 Feb. 11 | Patovirta |

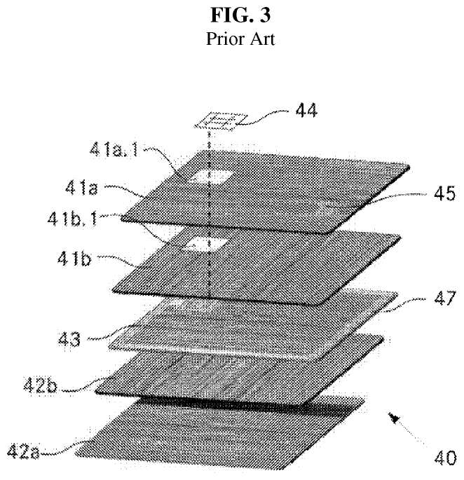

FIG. 2 is a partial view of the cross-section of a card. As shown in the cross-section of the card 20 in FIG. 2, the chip 24 and the electromagnetic coil 27 are fully embedded within the card body. Cards with such a structure turned out to be fully functional as required by standard ISO/IEC 7810:2019.

FIG. 3 shows a card 40 with electronic functionality. Card 40 comprises an upper part consisting of two laminated densified wood veneers 41a, 41b. The wood grain direction of the densified wood veneers 41a, 41b are perpendicular to each other. Both wood veneers 41a, 41b comprise a rectangular opening 41a.1, 41b.1 for receiving an integrated circuit chip 44. The outermost wood veneer 41a furthermore carries a printed logo 47 on the outer side.

A lower part of card 40 consists of two further laminated densified wood veneers 42a, 42b. Also in this case, the wood grain direction of the densified wood veneers 42a, 42b are perpendicular to each other.

In the middle of the card, there is an inlay 43 consisting of a wood veneer carrying an electromagnetic antenna 47 with contacts for chip 44. All of the layers 41a, 41b, 43, 42a, 43b of the card are adhesively bonded together in the final product.

Card 40 consists of five densified wood veneers whereby the wood grain direction of adjacent veneers are perpendicular to each other. Therefore, card 40 is especially robust from a mechanical point of view.

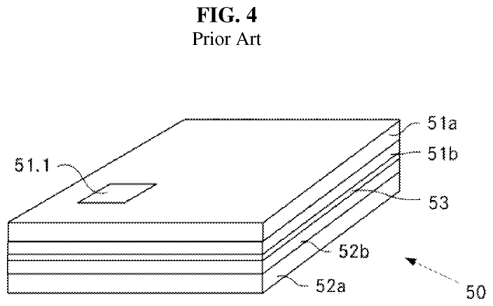

FIG. 4 is a perspective view of a card with electronic functionality. FIG. 4 shows a perspective view of another card 50 with electronic functionality. The card 50 is a laminated structure made from five layers of a hygroscopic material. Specifically, it comprises two top layers 51a, 52a of wood veneer, two thin mid layers 51b, 52b of wood veneer and an inlay layer 53 comprising a metal antenna 57 with contacts for a chip on a paper.

A thickness of each of the two top sheets 51a, 52a is for example 0.6 mm whereas a thickness of the two thin mid sheets 51b, 52b is for example 0.2 mm. The inlay layer 53 has for example a thickness of 0.1 mm.

Similar to card 40, card 50 comprises an opening or recess 51.1, respectively, for receiving an integrated circuit chip (not shown in FIG. 4). A symmetric setup as shown in FIG. 4 is suitable for direct connection or soldering, respectively, (“TE-Connect®”), i.e. conductive glue, “Asymmetric conductive foil (ACF)”, i.e. conductive gluing tape and “Coil-on-Module”, i.e. that belongs to group of Inductive-Coupling-chip-coupling technology. Also for the embedding of chip-coil-plug (the dual-interface chip and the antenna are on the same module/plug), the symmetric setup is suitable, as the card will not warp or deform beyond the requirements as defined in the ISO 7816.

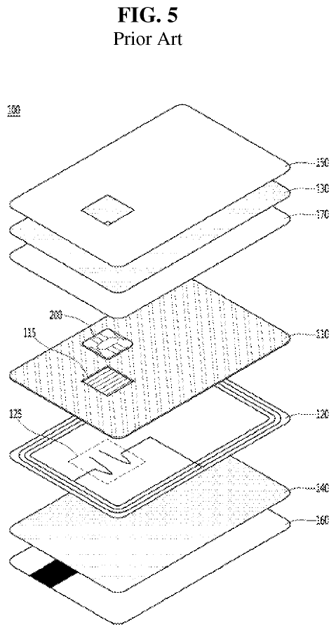

FIG. 5 is a perspective view showing a wooden card. A method of manufacturing a wooden card, the method comprising the steps of: processing a wood sheet; stacking the wood sheet on an inlay sheet including an antenna that will be connected to a COB chip; milling an area corresponding to the chip on the wood sheet, and forming a residual layer of a thickness smaller than that of the wood sheet; exposing end portions of the antenna passing through the residual layer from the inlay sheet located under the residual layer of the wooden sheet; and electrically connecting the chip and the end portions of the antenna.

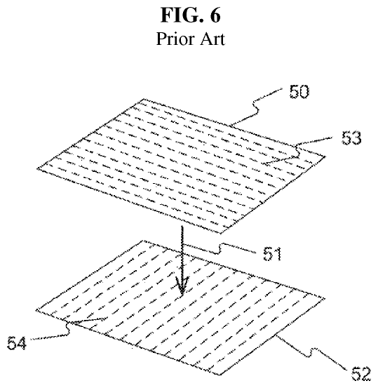

FIG. 6 is a schematic diagram showing an exemplary wood-on-wood inlay assembly process that may be performed at step 1006. In this exemplary embodiment, a first softened and thinned wood layer 50 of a first wood material is laminated to (as indicated by an arrow 51) a second softened and thinned wood layer 52 to form a laminated stack (i.e., a wood inlay stack). Again, the first and second wood materials herein may be the same or different, thus providing a flexibility in selecting wood materials for forming a wood inlay to meet various card performance and appearance criteria.

In some embodiments, at step 1006, a grain direction of a first wood layer may be rotated to a certain angular degree (e.g., 90 degrees) with respect to a grain direction of a second wood veneer layer that acts as a backing layer for the first wood veneer layer. Rotating the wood layers with respect to each other may increase inlay performance by improving the stiffness strength, resilience, and overall durability, even under stresses cause by multi-directional bending. In the exemplary embodiment shown in FIG. 11, a horizontal grain direction (as indicated by 53) of first wood layer 50 is rotated to 90 degrees with respect to a vertical grain direction (as indicated by 54) of second wood layer 52. That is, first wood layer 50 and second wood layer 52 are stacked with their grain structure perpendicular to each other. Herein, a horizontal grain direction indicates that the grain pattern may parallel the length of the card, while a vertical grain direction indicates that the grain pattern may parallel the width of the card.

### Further Description of Related Art and Some Objects of the Present Invention

Over 4.5 billion plastic payment cards are shipped worldwide, annually. The life span of a payment card is typically three years before renewal. With each containing approximately 5 grams of plastic, that equates to 22,500 tons each year, with most ending in landfill at end of life. This provides a significant opportunity for the payment card industry to affect change.

However, it is challenging to make ISO/IEC compliant payment cards from natural materials with precision, dimensional stability and functionality compared to those cards currently in use worldwide made of synthetic materials. Moreover, many natural materials like wood show intense swelling, shrinking and warpage behavior when exposed to moisture and water.

Smartcards, such as payment cards, including credit cards, debit cards, prepaid cards, loyalty cards, identity cards and access control cards have dimensions (ID-1) of 85.6 mm by 53.98 mm with a nominal thickness of 0.76 mm according to ISO/IEC 7810. The thickness being the limiting factor to achieve dimensional stability.

These cards are usually made of plastic such as PVC, PC or other polymeric materials. Semi-wood cards, used as keycards in hotels, with a PVC or PET core and a top and bottom layer made of non-densified wood material already exist. These semi-wood cards are disposable and non-recyclable. Furthermore, hybrid and full metal cards also exist in the payment card industry.

Replacing PVC in payment cards has already begun. Polyethylene terephthalate (Glycol) (PET-G) is an established alternative to PVC for payment cards. PET-G, contains no chlorine and no styrene meaning it has better end of life pathways, whether incinerated or placed in landfill.

Polylactic Acid (PLA) is a bio sourced plastic which can be used as an alternative to traditional synthetic plastics. PLA is produced from either corn or sugar starch, with the plant protein used as animal feed. This makes PLA arguably the most natural alternative to PVC currently available for use in payment cards.

Production of metal cards requires significantly more energy than is required to produce a PVC card, thus any metal card has a higher energy footprint than a PVC card and cannot be endorsed from a sustainability perspective. There are strong arguments regarding the recyclability of metal, however these could only be considered relevant if a program to collect and recycled expired metal payment cards was in place.

Replacing fossil fuel-based plastics in payment cards with renewable materials such as wood and biodegradable adhesive is of great interest to the payment card industry. However, making wooden cards from a solid layer of wood veneer is not feasible, because these wood materials do not permit the integration of an antenna circuit for contactless communication, nor fulfill the physical and mechanical requirements in terms of thickness, durability, dimensional stability (flatness and resistance to bending) and functional parameters as described in the various relevant standards, such as ISO/IEC 7810:2019 (including ISO/IEC 7811, 7813, 7816 and 14443), Mastercard Card Quality Management (CQM) specification and Card Structure and Integrity (CSI) Testing for all EMV smartcards.

As cited in US 2024/0001585, various approaches for modifying the mechanical and chemical properties of wood are known. Usually, these approaches are based on a two-step process involving a chemical modification such as chemical impregnation (liquid or gas phase) as a first step, followed by a physical treatment step. The physical treatment step can be heat treatment or a physical compression step at different temperatures and moisture contents. These approaches are known as hydrothermal modification (HTM) or viscoelastic thermal compression (VTC) methods.

To render densified or compressed wood materials dimensional stable, a deep and thorough (chemical and/or physical) modification of the wood specimen is required.

As further cited in US 2024/0001585, to render the surface of a wood material scratch resistant, usually a scratch resistant coating such as lacquer is applied, thus revealing a non-wooden surface, i.e. an unauthentic wood surface in terms of color, feel, glance, odor, but rather a surface with the properties of the coating material, namely having the appearance of plastic.

There is thus a need to provide improved solutions for a laminated wooden transaction card, which overcome the aforementioned drawbacks. Especially, there is a strong need to make available improved natural materials, which offer the possibility to replace synthetic materials in the stack-up construction of the card body.

It is an object of the invention to provide a laminated wooden transaction card comprising layers of natural wood veneer, layers of reinforcement, layers of eco-friendly adhesive and a core layer incorporating an antenna circuit. Especially, a card architecture that has improved properties with regard to dimensional stability (avoiding swelling and warpage), increased hydrophobicity (e.g. low moisture/water adsorption, increased water-repellency, low wettability), hardness, scratch-resistance, color-stability against ultraviolet (UV) and visible (VIS) light and/or temperature changes.

In particular, a further object of the invention is to provide a laminated wooden transaction card with precise surface texture (natural wood grain), structuration, stiffness and/or roughness.

Another object of the invention is to provide a laminated wooden transaction card comprising two or more outer layers of natural wood veneer sandwiching a core subassembly without densifying the wood veneer before final lamination of the complete assembly. Veneers can be rotary peeled, half round sliced, plain sliced, quarter sliced, or rift sliced veneers.

Another object of the invention is to provide a wooden transaction card comprising one or more layers of other material such as a metal foil (e.g. aluminum or anodized aluminum) or a metal layer (e.g. stainless steel or titanium) for mechanical reinforcement and aesthetic appearance.

Another object of the invention is to provide a laminated wooden transaction card with an in-card antenna circuit (inductive coil) for contactless communication based on natural materials such as copper or silver wire, embedded or scribed in a suitable substrate such as adhesive, paper or wood veneer, with improved properties. Especially, a card that complies with the physical requirements (form factor) in terms of dimensions (thickness, size), stability, durability, robustness, including mechanical properties and electrical parameters as defined by

ISO standards (e.g. standard ISO/IEC 7810:2019 for identification and payment cards). Including meeting the requirements of CQM/CSI and EMV.

The impregnated wood veneers obtained by this disclosure are suitable for laser-engraving with no incineration in comparison to natural wood veneer at a given laser fluence, ablation rate and repetition rate for specific wood species. This allows for customizing the surface structure of the impregnated wood veneer, thus allowing for customized haptics and wettability properties.

Specifically, it is possible to produce laminated card structures that essentially keep their shape, size and flatness under varying environmental conditions. Put differently, such kind of laminated card structures are substantially insensitive to varying humidity, wetness, temperature and/or pressure conditions.

Preferably, the outermost layers in the stack are made from natural wood veneer protected by an impregnation agent.

According to an embodiment of the invention, a surface structure and/or a surface texture of at least one outermost layer may be customized by embossing, e.g. by using a mechanical press with a texture and/or by using an embossing insert (textured lamination plate, textured silicone-based paper, etc.)

Moreover, the layers of wood veneer, especially the front and rear card surfaces, may receive customized features using conventional printing technology, depositing UV curable inks or water-soluble inks.

### Methods of Cutting Wood Veneer

In rotary peeling, the log is turned in a circular motion against a knife peeling off a continuous thin sheet of wood veneer (like unrolling wrapping paper), cutting micro thin wood veneers having a thickness in the range from 127 μm (5 mils), 140 μm (5.5 mils), 150 μm (6 mils), 178 μm (7 mils) or 203 μm (8 mils).

Flat cut, also called plain slicing is the most common method of veneer manufacturing, producing a grain pattern known as cathedral. Because each leaf in the flitch is similar, a consistent and even matching pattern is possible. The standard thickness of the wood veneer is typically 525 μm (~21 mils), 550 μm (~22 mils) or 600 μm (~24 mils), but alternative machine settings can achieve a thickness of 203 μm (8 mils), 254 μm (10 mils) or 305 μm (12 mils).

### Wood Impregnation

The principle of wood impregnation entails treating wood with a monomer/impregnating agent that diffuses into the cell walls, often followed by polymerization to change desired properties.

These processes can be grouped into two approaches: active modification involves the chemical alteration of wood structure by cross-linking, and passive modification features filling of cell cavities and/or cell walls with impregnating agents without any chemical reaction taking place.

Wood is a heterogeneous biomaterial that is prone to undergoing dimensional changes in response to easily changing atmospheric conditions. In addition, wood is also susceptible to environmental and biological attacks, so its durability and mechanical strength are often insufficient for long-term end uses. This has motivated a great deal of effort to find solutions to the issues raised by these drawbacks.

The principle of many impregnation processes entails treating wood with a monomer/impregnating agent, which then diffuses into the cell walls, followed by polymerization to impart the desired properties. Both active modification by cross-linking and passive modification by bulking are included in this process. Hardwood and softwood have been impregnated with a variety of impregnating agents such as waxes and oils, thermosetting resins, including epoxy, phenol formaldehyde, urea formaldehyde, etc., monomer/polymer, including methacrylate, acrylate, styrene, unsaturated polyester, followed by radiation or catalyst-thermal treatment, noncyclic and cyclic anhydride, as well as organic acid). These types of impregnating agents have been classified as either nonbonded-leachable (NBL), nonbonded-non-leachable (NBNL), or bonded-non-leachable (BNL), depending on the bonding efficiency of the impregnating agent to and from the wood cells.

### REFERENCE IS MADE TO

Augustina, S., Dwianto, W., Wahyudi, I., Syafii, W., Gérardin, P., and Marbun, S. D. (2023). “Wood impregnation in relation to its mechanisms and properties enhancement,” BioResources 18(2), 4332-4372.
Md. Rowson Ali, Ummi Hani Abdullah, Zaidon Ashaari, Norul Hisham Hamid and Lee Seng Hua (2021). “Hydrothermal Modification of Wood: A Review”, Polymers 2021, 13(16), 2612.

### Some Terminology

Some of the following terms may be used or referred to, herein.

### Sacrificial Layer (SFL)

A sacrificial layer is a temporary material or film that is intentionally used and then removed to enable the creation of a final surface structure on the front and rear face of a laminated sheet assembly (LSA) having an array of card body sites comprising outer layers of wood veneer (WL). A sacrificial layer is arranged between the top and bottom lamination plate, sandwiching the sheet assembly in preparation for press lamination. During compression or densification of the sheet assembly in a lamination press, internal layers of adhesive melt and seep through the pores of the wood veneers, with the sacrificial layer (on each side of the assembly) acting as a back-stop to the flow of adhesive resin. The sacrificial layer also prevents adhesive accumulating on the surface of the (glossy) lamination plates. Post lamination and removal of the sacrificial layers, the front and rear (exposed) surfaces may have a polymeric finish with a surface roughness Ra<1 μm. This polymeric finish may be laser engravable. The sacrificial layer may be a polyethylene terephthalate (PET) release film or a film mixture of polyethylene terephthalate, acrylated epoxy mixture and diatomaceous earth. The release film may impart a surface roughness to the adhesive filled pores of the wood veneer. The release film may be replaced by a (Teflon) coated lamination plate.

### Subassembly Tacking

After alignment and collating of the layers forming the stack-up assembly in preparation for press lamination, the bundle may be joined or fastened together using temporary staples.

### Substrate Layer (SL) for Ultrasonic Wire Embedding

Wire embedding is a technique for integrating a conductive wire (insulated or uninsulated) onto or into a substrate layer in forming an electrical circuit such as a configuration of antenna elements, also known as a booster antenna circuit (BAC). The process involves pressing or fusing the conductive wire onto or into the surface or into pre-defined channels. The substrate layer (SL) may be a deformable material such as adhesive, paper, plastic or pulp (including polymers and composites). The substrate layer (SL) may have a coating of adhesive to enhance adhesion. The wire conductor may be countersunk into the material using an ultrasonic embedding tool (aka a sonotrode). The wire conductor may be a self-bonding insulated copper wire remaining fixed in position at a certain depth after scribing under pressure and friction (temperature) into the material. The ultrasonic energy deforms the substrate's surface, creating a channel to securely hold the wire, requiring a material that can be deformed without cracking or losing its structural integrity. The substrate layer (SL) incorporating an array of booster antenna circuits (BAC) may be replaced by an array of plated copper antenna circuits on an acrylic carrier or aluminum etched antenna circuits on a PET carrier.

### ISO Compliant Thickness of a Laminated Sheet Assembly or a Singulated Card Body

The lamination parameters (pressure, temperature and dwell time) determine the degree of shrinkage of the complete stack-up assembly during press lamination. However, the resultant thickness is also determined by the thickness and material composition of the interlayers forming the assembly.

### Choice of Lamination Parameters

For a given stack-up assembly of material layers (e.g. wood species, adhesive layers, reinforcement layers, core substrate layer, antenna structure and footprint, etc.), the choice of lamination parameters determines the shrinkage of the laminated assembly and the stiffness/bendability, breakpoint and weight of the final card body. Said lamination parameters also determine the force required to delaminate or separate the material layers. The strength of the card body along its lengthwise and crosswise directions is also determined by the lamination parameters and the orientation of the grain direction in each of the wood veneer and reinforcement layers.

### Moisture Content

The moisture content (MC) of wood veneers typically ranges from 8% to 12% after drying at the mill (considered “well-seasoned timber”), with some variations between manufacturers and depending on the intended application. The application of hotel key cards usually requires lower moisture levels (around 6-9%, considered “dried-out timber”). Achieving a uniform and controlled MC is crucial, as it affects the veneer's mechanical properties, bonding strength, and overall quality.

Conversely, a higher moisture content MC of the wood veneer layers (WL) facilitates thickness uniformity and stability during and after lamination (under induced pressure and temperature), with the moisture chemically interacting with the molten thermoplastic adhesive resin flowing through the pores of the wood veneers. High moisture content improves the interlayer bonding, and avoids thickness expansion (spring-back) after press lamination.

Storage conditions at 60% relative humidity at room temperature increase the moisture content of the delivered wood veneers from the mill before press lamination.

The teachings of US 2024/0001585 are not applicable as a pre-conditioning cycle (to remove moisture at a temperature of 50-100° C. and a pressure of 0 to 2 MPa (0-200 N/cm²)) is not desirable.

### Plasma Surface Treatment

Plasma treatment, also known as plasma cleaning, plasma etching, plasma surface modification or activation, involves striking the surface with high energy electrons and ions. This modifies the physical and chemical structure of the very top (exposed) layer and changes surface wettability and functionalization. With plasma surface activation, the material's surface is much more conducive to adhesion for bonding, digital printing, screen printing, coating, and the like.

Plasma treatment becomes an indispensable tool for processing low surface energy solids such as plasticized or polymeric surfaces including densified adhesive induced surfaces like laminated wood veneers. Reference is made to internet.plasmatreat.com/de/

### Lamination Parameters for Compressing or Densifying a Stack of Wood Veneers

The teachings of US 2024/0001585 emphasize a three-step approach to the lamination process in densifying a wooden card structure: (i) a pre-conditioning cycle (first temperature: 50-100° C.-first pressure: 0 to 2 MPa (0-200 N/cm²)-dwell time: 1 min-10 hours), (ii) press lamination cycle (second temperature (same as first temperature): 50-100° C.-second pressure: 9-50 MPa (900-5000 N/cm²)-dwell time: 1-45 min and increasing the second temperature: 100-220°—keeping the second pressure: 9-50 MPa (900-5000 N/cm²)-dwell time: 1-120 min), and (iii) a cooling cycle (reducing to room temperature: 22° C. and reducing to ambient pressure).

In the present invention, a pre-conditioning cycle to remove moisture content after drying the wood veneers at the mill (with a resultant moisture content in the range of 6-9%) is not considered desirable. The selection of material layers in the stack-up assembly and their thickness in combination with the choice of lamination parameters determines the level of shrinkage, final thickness and ultimately the weight of the compressed or densified material layers. Three classification ranges of lamination parameters have been defined.

### Medium Pressure

A stack of wood veneer layers, adhesive layers and a core substrate layer in forming a card body structure may be press laminated at a pressure in the range of 1.5-2.0 MPa (150-200 N/cm²) at a temperature of approximately 140-150° C. for a dwell time of 15 to 30 minutes, with the post lamination thickness of the assembly achieving ISO thickness compliance without the process of sanding-back the laminated assembly, but with a limitation on the thickness of the individual material layers forming the stack-up assembly and a reduced weight of the card body compared to laminating at high or very high pressure using thicker materials;

### High Pressure

The press lamination may be performed in a single, continuous lamination process (linear, gradual (curved) or exponential) using a pressure between 2.0-8.5 MPa (200 N/cm² and 850 N/cm²) at a temperature between 135° C. and 150° C. for a dwell time between 30 and 50 minutes followed by a cooling cycle to ambient pressure and temperature, allowing for thicker individual material layers forming the stack-up assembly to be applied and achieving an increase in the weight of the card body; and

### Very High Pressure

A densification pressure of 9-50 MPa (900-5000 N/cm²) as proposed by the teachings in US 2024/0001585 defines a pressure range which is not applicable in the production of wooden smartcards.

The press lamination may be performed in a single, continuous lamination process (linear, gradual (curved) or exponential) using a pressure between 8.5-12.5 MPa (850 N/cm² and 1250 N/cm²) at a temperature between 135° C. and 150° C. for a dwell time between 30 and 50 minutes followed by a cooling cycle to ambient pressure and temperature, allowing for substantially thicker individual material layers forming the stack-up assembly to be applied and achieving a significantly higher increase in the weight of the final card body.

Below 1.5 MPa (150 N/cm²), the pressure may be considered “low pressure”, often referred to as kiss lamination pressure.

Above 12.5 MPa (1250 N/cm²), in the range of 12.5-50 MPa (1250-5000 N/cm²), the pressure may be considered as “ultra-high pressure”.

Put differently, for a given stack-up construction of material layers in forming a card body structure having a thickness before press lamination of 1700 μm (front SWL (Maple: 550 μm)+AL (25 μm)+PWL (Maple: 200 μm)+AL (25 μm)+core SL (100 μm) with BAC+AL (25 μm)+PWL (Maple: 200 μm)+AL (25 μm)+ (rear SWL (Maple: 550 μm), the following pressure ranges define a certain post lamination thickness of the assembly:
a single, continuous lamination cycle at Medium Pressure (2.0 MPa (200 N/cm²) at a temperature of 150° C. for a dwell time of 15 or 30 minutes), the post lamination thickness of the stack-up assembly is approximately: 1200 μm, representing a shrinkage of 29%, and thus requiring a reduction in the thickness of the individual wood veneer layers forming the stack-up assembly to reach an ISO card body thickness of 800 μm, with the consequences of a reduction in the card body weight and its mechanical strength or robustness;
a single, continuous lamination cycle at High Pressure (8.5 MPa (850 N/cm²) at a temperature of 150° C. for a dwell time of 30 or 50 minutes), the post lamination thickness of the stack-up assembly is approximately: 810 μm for both durations of lamination, representing a shrinkage of 52-53% with the color of the surface finish on both sides of the card body from the internal melting of the adhesive varies with the duration of lamination, brighter at 30 minutes and slightly darker at 50 minutes;
a single, continuous lamination cycle at Very High Pressure (12.5 MPa (1250 N/cm²) at a temperature of 150° C. for a dwell time of 30 or 50 minutes), the post lamination thickness of the stack-up assembly is also approximately: 810 μm, representing a shrinkage of 52-53%, but with a noticeable difference in the color of the surface finish on both sides of the card body which is attributable to the higher pressure and duration of lamination resulting in a color from light brown to dark brown.

The above results demonstrate that for a given stack-up construction, such as described above, with an initial thickness of 1700 μm, the post lamination thickness of the assembly, in applying a pressure of 850 N/cm² or 1250 N/cm² at a temperature of 150° C. for a dwell time of 30 minutes is approximately 800 to 810 μm (representing a shrinkage of 52-53%) at both pressure levels, without a preconditioning cycle to remove moisture. Therefore, a press lamination pressure of 850 N/cm² at a temperature of 150° C. for the abovementioned stack-up construction represents a threshold point in the compression process, with a dwell time of 30 or 50 minutes regulating the color of the surface finish on both sides of the card body.

Note that in applying a pressure of 850 N/cm² at a temperature of 150° C. for a dwell time of 15 minutes for the same stack-up construction, the post lamination thickness is approximately 860 μm representing a shrinkage of 49%, requiring a reduction in the thickness of material layers to be ISO conform.

The lamination parameters, in particular the applied pressure and dwell time may be further optimized by reducing the thickness of the individual layers of wood veneer, such as the front and rear face sliced wood veneer having a thickness of 550 μm which could be reduced to 525 μm, or reducing the thickness of intermediate rotary peeled wood veneer layers from 200 μm to 150 μm, and interchanging the hard wood species from maple to birch to achieve a different compression. However, a reduction in the thickness of the material layers has an impact on the weight of the card body.

The dwell time determines the production capacity and its time reduction is essential for an increased production throughput.

### Adhesive Coated Wood

Rotary peeled or sliced wood veneer layers may be coated on one or both sides with a thermoplastic adhesive such as polyvinyl acetate (PVA, PVAc), commonly known as wood glue. A wire antenna may be scribed into a PVAc coated wood veneer in forming a booster antenna circuit (BAC).

### Curtain Coating

Curtain coating is a non-contact process for applying a uniform, pre-metered layer of adhesive onto a moving substrate by guiding the substrate through a free-falling, stable curtain of the coating resin. This method offers precise, consistent coating thickness and excellent coverage, making it ideal for products like specialty papers, fleece and wood veneers.

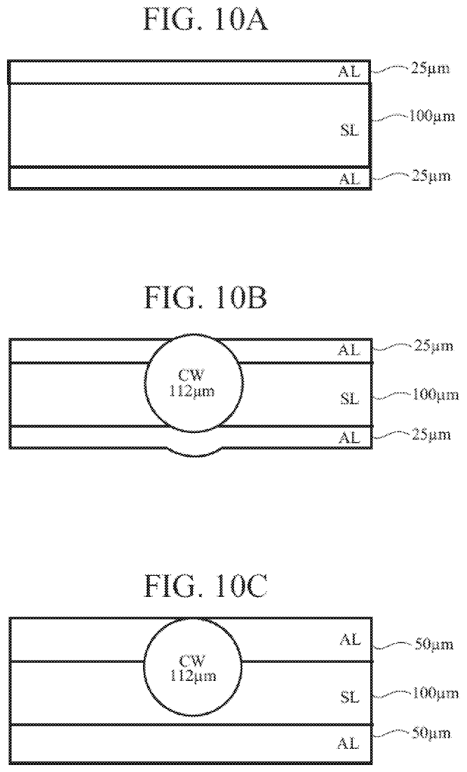

### Multifunctionality of the Core Adhesive Coated Substrate Layer (ACSL) (FIG. 10)

The core adhesive coated substrate layer (ACSL), comprising a substrate layer (SL) such as nonwoven fabric (i.e. cellulose (CE) and synthetic fibers (SF) bonded with a latex binder (LB)) and coated on both sides with a thermoplastic adhesive layer (AL) or adhesive layers applied by way of film transfer, has multiple functionalities in the stack-up construction of a wooden transaction card (WTC) or smartcard (SC):
The substrate layer (SL) provides reinforcement to the structure of the card body (CB) while the adhesive coating (AC) or adhesive film transfer (AFT) on both sides of the substrate provides for interlayer bonding between a sandwich of upper and lower wood veneer layers (WL);
The adhesive coating (AC) or the adhesive film transfer (AFT) on the substrate layer (SL) facilitates the embedding and forming of an array of booster antenna circuits (BAC) for radio frequency communication;
The core adhesive coated substrate layer (ACSL) incorporating the array of booster antenna circuits (BAC) occupies a larger dimensional footprint than the other layers (wood veneer, adhesive and substrate layers) forming the stack-up assembly. Put differently, the core adhesive coated substrate layer (ACSL) after final lamination protrudes beyond the dimensional area covered by the laminated stack of wood veneer, bonding and substrate layers;
Printed dotted or solid lines (for visual alignment) on the surface of the adhesive provide for positional guidance in assembling or collating the various layers of wood veneer to the core adhesive coated substrate layer (ACSL) incorporating the array of booster antenna circuits (BAC), and post lamination of the assembly used as a reference for trimming in providing straight and sharp edges;
Fiducials (for optical alignment) in the form of printed T-marks on the surface of the adhesive provide for alignment relative to the position of each card body site, and post lamination of the assembly used as a reference for punching or laser cutting the card bodies from the laminated assembly (singulation process); and
Index or pilot holes, typically two (for mechanical alignment) are also used for reference in the application of the magnetic stripe to the laminated sheet assembly, and or for precision cutting of the rough edges.
Post lamination of the assembly, the visual and optical alignment tools are located outside the area of the laminated stack. The mechanical alignment tools may be exterior or interior to the laminated stack.

### Lamination Cycle Time

Lamination cassettes are typically used in the production of smartcards and may accept up to 10 collated assemblies (each assembly being a stack-up of multiple layers in a production format, placed between lamination plates) and held in a fixed position to ensure accurate alignment. The loaded cassette may be placed in a daylight of a lamination press, and for a given temperature and pressure, the dwell time may be 30 minutes. A lamination press may have multiple daylights.

Alternatively, a single collated assembly may be placed between lamination plates and for a given temperature and pressure, the dwell time may be only 6 minutes. Depending on the size of the working table in the press and the lamination plates, several collated assemblies may be placed side by side, to increase the throughput.

### Dimensional Elongation of the Stack-Up Assembly

A 5-ply stack-up assembly in a 25-up production format (320 mm×465 mm) comprising five layers of rotary peeled wood veneer and four adhesive coated substrate layers with a thickness before lamination of approximately 1350 μm (such as 1300-1400 μm), shrinking in the lamination press to 800 μm under a pressure of 200 N/cm² at a temperature of 150° C. for a dwell time of 6 minutes. The layers of wood veneer expand in the lengthwise direction (horizontal axis) by 1-2 mm (0.5-1.0 mm on each side (left & right) of the laminate) while the adhesive coated substrate layer expands in the same direction by 7-8 mm (3.5-4.0 mm on each side (left & right) of the laminate), leaving very rough edges requiring trimming. There is virtually no expansion in the crosswise direction (vertical axis). This lengthwise expansion of the material layers in the post laminated stack may cause the position of the visual, optical and mechanical alignment guides to shift, requiring dimensional compensation.

### Thickness Limitation Frame & Resistance Pressure Measurement

Depending on the thickness of the material layers forming the stack-up assembly (wood veneer species, array of antenna circuits, adhesive, reinforcement and substrate layers), the post lamination thickness of the assembly (pressure dependent) may vary significantly. This variation in thickness from one laminated sheet to the next and across the entire area of the laminated sheet assembly impacts the production yield. This variation in the post lamination thickness can be attributed to the composition (material density of the veneers and their wood grain), presence of the array of antenna circuits, and the thickness tolerance of the individual layers, resulting in a wide range of thicknesses for a given pressure. For example, measuring at multiple points across a laminated sheet, the spread in thickness may range from a lowest value of 740 μm to a highest value of 860 μm (with a mean value of 810 μm), representing a spread of 120 μm. To confine this dimensional spread in material thickness to a range of +20 μm, it is possible to sand-back the laminated sheet assembly to be ISO thickness conform. Alternatively, an unlaminated sheet assembly may be placed between a metal frame having a thickness of 760 μm. In compressing the sheet assembly, the laminator detects the resistance to pressure caused by the presence of the metal frame, acting as a dimensional end-stop.

### Ageing Effect

The lamination of a stack-up assembly comprising outer layers of sliced wood veneer (SWL: 550 μm and inner layers of rotary peeled wood veneer (PWL: 200 μm) causes the internal bonding layers of adhesive to seep through the pores of the wood veneer layers to the outermost front and rear layers of the assembly leaving a surface finish with a glossy sheen. This exposure to pressure and temperature for a defined duration causes the wood glue to yellow and to change the color of the wood veneer. For a given temperature (150° C.) and application of pressure (e.g. 850 N/cm² or 1250 N/cm²) over a dwell time of 30 to 50 minutes, the color of the wood veneer can be changed from a bright to a dark brown, as if the wood veneer layers had undergone a process of accelerated ageing.

### Micro-Thin Wood Veneers and a Reduction in Lamination Pressure

The thicker the layers of wood veneer in forming the stack-up assembly, such as two layers of sliced wood veneer (SWL: 550 μm) in combination with two layers of rotary peeled wood veneer (PWL: 200 μm) adhesively attached together using 4 layers of adhesive (AL: 25 μm) with a core substrate layer (SL: 100 μm) incorporating a booster antenna circuit (BAC), the greater the pressure required to compress the stack with an initial thickness of 1700 μm to an ISO conforming thickness of 800 μm (typical lamination parameters: a pressure of 850 N/cm² at a temperature of 150° C. for a dwell time of 30 minutes (10 collated assemblies in a cassette); conversely the thinner the layers of wood veneer in forming the stack-up assembly, such as five layers of micro-thin rotary peeled wood veneer (PWL: 150 μm) and four adhesive coated substrate layers (ACSL: 150 μm) with the core ACSL incorporating a booster antenna circuit (BAC), the lower the pressure required to compress the stack from an initial thickness of approximately 1350 μm (such as 1300-1400 μm), to an ISO conforming thickness of 760-800 μm (typical lamination parameters: a pressure of 200-300 N/cm² at a temperature of 135° C. to 150° C. for a dwell time of 6 minutes (single stack-up assembly placed between lamination plates)).

### Calendering

Calendering of fabrics is a finishing process used to smooth, coat, or thin a material like paper or fleece. It is a process of smoothing and compressing a material (notably paper or fleece) during production by passing a single continuous sheet through a number of pairs of heated rolls. The rolls in combination are called calenders.

### Substrate Layers

The following material layers may be used in the construction of wooden transaction cards: Paper (thin sheet of matted cellulose fibers); Parchment (a type of cellulose-based paper that has been chemically treated to be resistant to grease and moisture); Kraft Paper (produced from chemical pulp); Nonwoven (cellulose and fibers); Needle Punch Nonwoven (a type of fabric made by mechanically interlocking fibers) and Nonwoven Spun Bond (a type of fabric made by extruding molten polymer into continuous filaments). The material layers may be coated with an adhesive for interlayer bonding and to facilitate the integration of electronic components such as an antenna circuit.

### Wetlaid Nonwoven Fabrics

Wetlaid nonwoven fabrics comprise a blend of cellulosic and polyester fibers bonded with a latex binder. The weight of the fabric may be for example 70 g/m² with a thickness before adhesive coating of 220 μm. The adhesive coating may be applied to both sides of the fabric from a water-based system in combination with sufficient press temperature and pressure (calendering process). Post calendering and adhesive coating, the weight is approximately 100 g/m² with a thickness of 150 μm (having a tensile strength in the longitudinal direction of 2460 N/m and a tensile strength in the lateral direction of 1510 N/m).

### Glass Fiber Nonwoven Fabrics

A wetlaid nonwoven made of a blend of cellulose, glass and polyester bonded with a hydrophilic synthetic binder. The weight for example may be 90 g/m² and a thickness before adhesive coating, drying and calendering of 345 μm.

Glass fibers may represent 70% of the fabric. The function of cellulose is to absorb glue, polyester fibers for elongation and glass fibers for mechanical strength.

### Dyed Wood Veneers

Wood veneer dyeing technology involves immersion-based methods, often using pressurized tanks to force a dye solution deep into the wood. These processes, which can also be enhanced by technologies like ultrasound, aim for uniform color penetration throughout the veneer's thickness, unlike surface-only stains. Key steps include dye absorption under pressure or vacuum, followed by washing and drying.

Wood veneers in a variety of colors may be used to create aesthetic effects in the construction of wooden transaction cards. Typically, wood veneers with a thickness greater than 300 μm can be dyed.

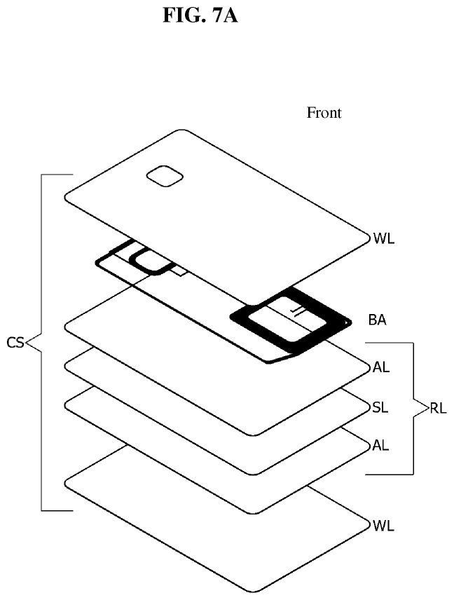

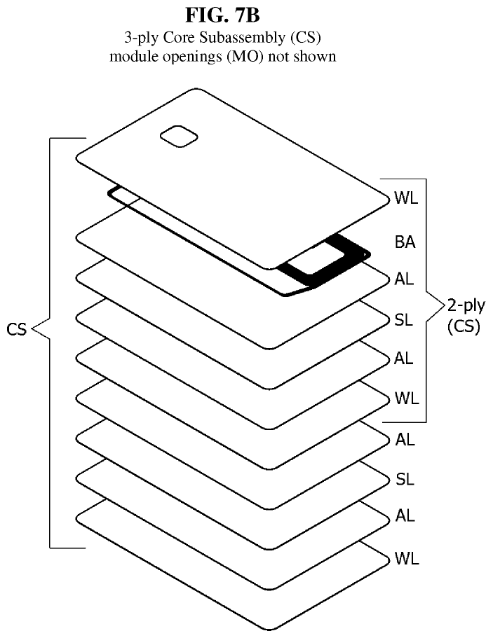

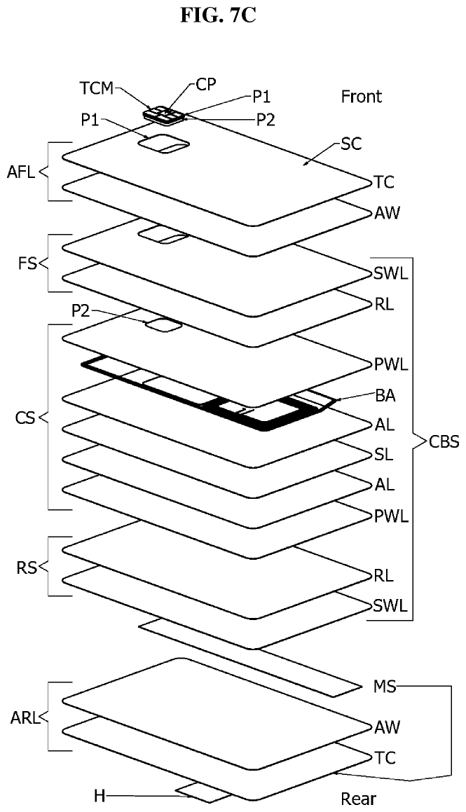

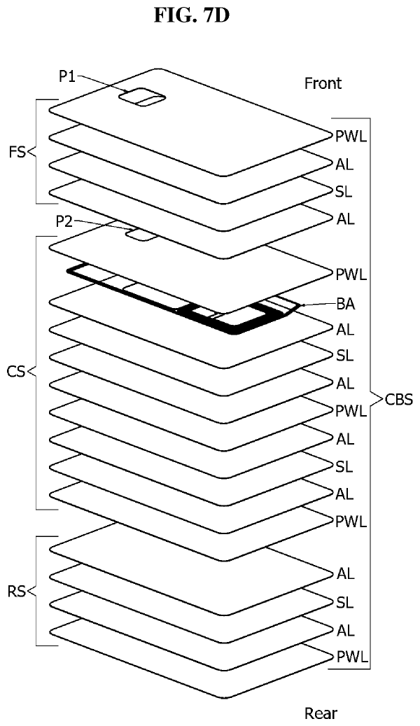

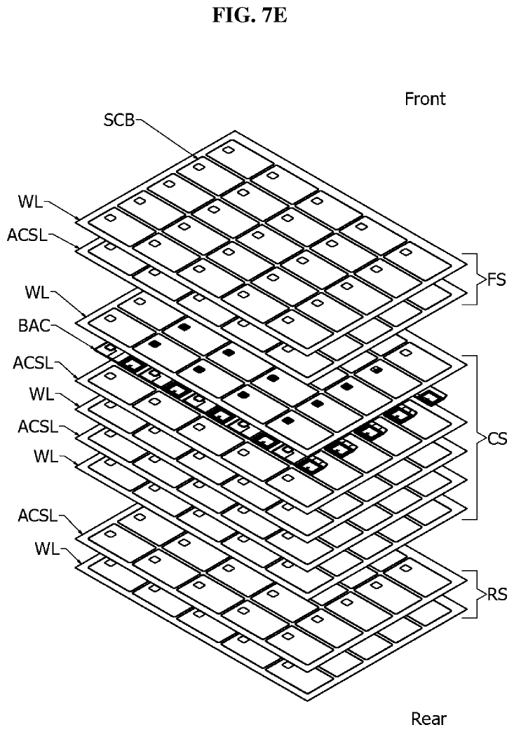

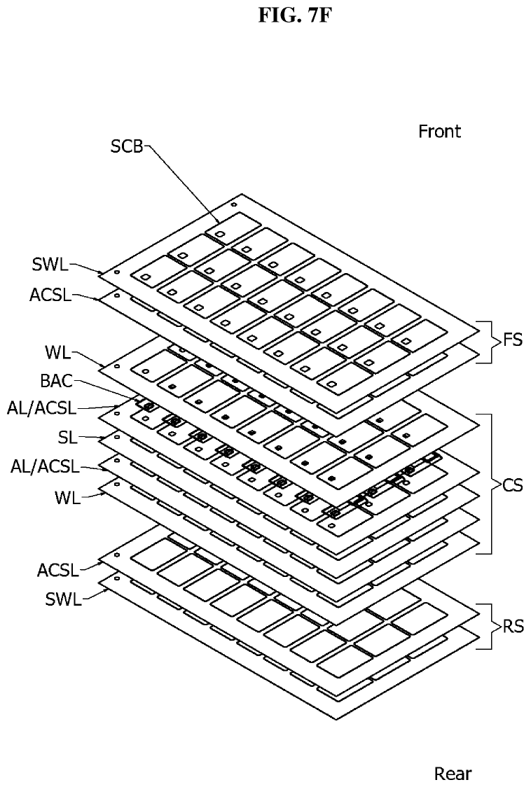

FIG. 7A shows a 2-ply core subassembly (CS) of a wooden transaction card (WTC) comprising upper and lower wood layers (WL) sandwiching a substrate layer (SL) of nonwoven fabric coated on both sides with an adhesive layer (AL) to function as a bonding layer (BL) and reinforcement layer (RL) wherein a booster antenna (BA) is embedded into the top adhesive layer (AL) of said adhesive coated substrate layer (ACSL).

According to an embodiment of the invention, the core subassembly (CS) of a wooden transaction card (WTC) may comprise two layers (upper and lower) of wood veneer (e.g. micro thin rotary peeled wood veneer (RPWV) such as maple or birch with a thickness of 150 μm) sandwiching a substrate layer (SL) of nonwoven fabric (~100 μm (post calendering from an initial thickness of ~220 μm)) coated on both (top and bottom) sides with an adhesive layer (~25 μm) having an overall thickness of 150 μm before press lamination, wherein the top adhesive layer incorporates an antenna structure (AS) such as a wire embedded antenna or antenna circuit (comprising self-bonding insulated copper wire (bare copper wire Ø: 80 μm or 112 μm) having 3-4 turns and occupying (disposed in) an area representing 10 to 15% of the total surface area of the card body (4,621 mm²) and wherein the adhesive, such as a wood glue (PVAc), on both sides of the nonwoven substrate layer functions as a thermoplastic bonding agent in the press lamination process, adhesively attaching the upper and lower wood veneers to the inner substrate of nonwoven fabric in the presence of the antenna structure (AS). See, for example, FIG. 7A.

The inner substrate layer (SL) of nonwoven fabric coated on both sides with an adhesive layer (AL) may be considered as a bonding layer (BL) and reinforcement layer (RL). Said adhesive coated substrate layer (ACSL) may be provided with pilot holes (punched, milled or drilled) and printed fiducials for alignment purposes. The core subassembly (CS) may be pre-laminated before laminating the complete stack-up assembly.

Said reinforcement layer (RL) comprising a wetlaid nonwoven fabric (of cellulose, synthetic and organic fibers bonded with a latex binder) or pulp and fiber in a latex binder may be laid in a specific direction and coated on both sides thereof with adhesive by way of adhesive transfer or curtain coating having a total thickness of 150 μm.

In this, and some other embodiments disclosed herein, the reinforcement layer (RL) comprises a substrate layer (SL) with adhesive layers (AL) on both (front and rear) sides thereof.

An individual core subassembly (CS) of the wooden transaction card (WTC), measuring approximately 53.98 mm×85.60 mm, may be representative of one of a plurality of sites in an array of card body sites of the multilayered inlay), such as a 24-up (e.g. 3×8) format having dimensions of 360 mm×605 mm.

The pre-lamination thickness of the core subassembly ((upper) wood veneer (WV or WL: 150 μm), (top) adhesive layer (AL: ~25 μm), substrate layer of nonwoven fabric (SL: ~100 μm (post calendering from an initial thickness of ~220 μm)), (bottom) adhesive layer (AL: ~25 μm) and (lower) wood veneer (WV or WL: 150 μm) may be 450 μm.

The wire embedded antenna (max wire Ø: 105 μm (bare copper wire Ø: 80 μm) including insulation) may be ultrasonically scribed into the top side of the adhesive coated substrate layer (comprising fleece) having a thickness of 150 μm, countersinking the wire conductor into the substrate material during the embedding process.

For the wire embedding process, the substrate layer (SL) of nonwoven fabric may be coated initially only on one side with adhesive (i.e. top side) having a total thickness of 125 μm, and post embedding coated on the other side (e.g. bottom side) with another layer of adhesive (25 μm).

The force of wire embedding via an ultrasonic tool (aka sonotrode) operating at a frequency of 60 or 70 kHz may range from 5 to 10 N, while the speed along the straight segments of the antenna coil may range from 2,000 to 4,000 mm per minute and on the curve and meander sections of the coil from 4,000 to 10,000 mm per minute.

The lamination parameters of the core subassembly (CS) may for example be 15 kg per cm² of pressure at a temperature of 140° C. for a dwell time of 6 minutes. This equates to 147 N/cm² across an area of 360 mm×605 mm, representing 32.7 tons of pressure.

The post lamination of the core subassembly (CS) with two layers of wood veneer (2-ply construction) may have a thickness of 335 μm=15 μm.

FIG. 7B shows a 3-ply core subassembly (CS) of a wooden transaction card (WTC) comprising upper and middle wood layers (WL) sandwiching a substrate layer (SL) of nonwoven fabric coated on both sides with an adhesive layer (AL) with a booster antenna (BA) incorporated into the top adhesive layer of said adhesive coated substrate layer (ACSL) as presented in FIG. 7A, and further comprising a lower wood layer (WL) with an adhesive coated substrate layer (ACSL) assembled between the middle and lower wood layers.

The core subassembly (CS) of a wooden transaction card (WTC) may comprise three layers (upper, middle and lower) of wood veneer (e.g. micro thin rotary peeled wood veneer (RPWV) such as maple or birch with a thickness of 150 μm) and two substrate layers of nonwoven fabric (~100 μm (post calendering from an initial thickness of ~220 μm)) coated on both sides with an adhesive layer (~25 μm) having an overall thickness of 150 μm, wherein a first adhesive coated substrate layer (1st ACSL) is arranged between the upper and middle layer of wood veneer (WV or WL) and a second adhesive coated substrate layer (2nd ACSL) is arranged between the middle and lower layer of wood veneer (before press lamination), wherein the top adhesive layer of the first adhesive coated substrate layer (1st ACSL) between the upper and middle layer of wood veneer incorporates an antenna structure (AS) such as a wire embedded antenna circuit (comprising self-bonding insulated copper wire (bare copper Ø 80 μm or 112 μm) having 3-4 turns and occupying an area representing 10 to 15% of the total surface area of the card body (4,621 mm²) and wherein the adhesive, such as a wood glue (PVAc), on both sides of the first adhesive coated substrate layer (1st ACSL) functions as a thermoplastic bonding agent in the press lamination process, adhesively attaching the upper and middle wood veneers to the inner substrate of nonwoven fabric, in the presence of the antenna structure (AS). Alternatively, the antenna structure may be a plated copper antenna. See, for example, FIG. 7B.

The post lamination of the core subassembly (CS) with three layers of wood veneer (3-ply construction) may have a thickness of 545 μm±15 μm.

The core subassembly having a 2- or 3-ply construction may be further laminated between two layers (front and rear) of rotary peeled wood veneer or sliced wood veneer using two layers of adhesive coated nonwoven fabric (fleece) to complete the stack-up construction of the card body. The lamination parameters, compressing the layers together, determines the thickness of the laminated assembly.

The exposed outer layers of wood veneer (front and rear layers of rotary peeled or sliced wood veneer) may be impregnated with a substance such resin, varnish, lacquer or enamel before press lamination, wherein the substance during press lamination seals the pores of the wood veneer. Alternatively, the substance may be applied thereto post lamination of the assembly.

A sacrificial layer such as a release film, placed between the lamination plates and the wood veneer assembly for compression in a lamination press, may be coated with a primer to promote adhesion of digital ink, with a sealant for impregnation (water proofing), with a colorant for staining, with a resin for robustness or with a polymer to create a very smooth surface (plasticizing). Post lamination of the assembly, the surface finish of the exposed outer layers of wood veneer may be changed in terms of texture (touch and feel), color and strength.

The teachings of US 2024/0001585 emphasize a three-step approach to the lamination process in densifying a wooden card structure: (i) a pre-conditioning cycle (first temperature: 50-100° C.-first pressure: 0 to 2 MPa (0-200 N/cm²)-dwell time: 1 min-10 hours), (ii) press lamination cycle (second temperature (same as first temperature): 50-100° C.-second pressure: 9-50 MPa (900-5000 N/cm²)-dwell time: 1-45 min and increasing the second temperature: 100-220°—keeping the second pressure: 9-50 MPa (900-5000 N/cm²)-dwell time: 1-120 min), and (iii) a cooling cycle (reducing to room temperature: 22° C. and reducing to ambient pressure).

When using preconditioned wood veneers from the mill with a moisture content in the range of 6 to 9% and pre-laminating the core subassembly before final lamination, the teachings of US 2024/0001585 do not apply. Firstly, a pre-conditioning cycle (to remove moisture at a temperature of 50-100° C. and a pressure of 0 to 2 MPa (0-200 N/cm²)) is not required and secondly, a (very high) densification pressure of 9-50 MPa (900-5000 N/cm²) is not required to compress the stack-up assembly of wood veneers and adhesive coated substrate layers to ISO thickness as disclosed in FIGS. 7C and 7D.

FIG. 7C shows a smartcard comprising a 4-ply card body subassembly (CBS). The front and rear subassemblies (FS and RS, respectively) and the core subassembly (CS) are shown for context.

In this figure, the 6 or 8 pin chip module (CM), the magnetic stripe MS, and the additional front and rear layers (AFL and RFL, respectively) are also shown, but may be omitted in other figures, for illustrative clarity.

A booster antenna (BA) is shown, embedded into the central adhesive coated substrate layer (ACSL) also functioning as a bonding layer (BL) and reinforcement layer (RL) of the core subassembly (CS) which is disposed between an upper intermediate wood layer (IWL, WL or PWL) and a lower intermediate wood layer (IWL, WL or PWL).

The booster antenna BA may be embedded, such as by scribing wire into the adhesive layer on the top (front) surface of the adhesive coated substrate layer (ACSL=AL+SL+AL).

The booster antenna (BA) or booster antenna circuit (BAC) shown in FIG. 7C was illustrated as round wire, embedded into the adhesive layer (AL) of the underlying substrate (SL). Optionally, the wire conductor may be embedded into an adhesive layer (AL) applied to an underlying wood layer (WL or PWL).

The adhesive coated substrate layer (ACSL=AL+SL+AL) may also be referred to as an adhesive coated fleece (ACF) or simply a reinforcement layer (RL) comprising a substrate layer (SL) of nonwoven fabric comprising cellulose (CE), synthetic fibers (SF) bonded with a latex binder (LB) coated on one or both sides with an adhesive layer (AL).

The substrate layer (SL) for reinforcement may comprise a nonwoven fabric (fleece), a hybrid construction of nonwoven and fiberglass or a hydroentangled nonwoven.

Alternatively, the substrate layer may be a paper layer (PL) and coated with adhesive, referred to as adhesive coated paper (ACP).

FIG. 7C: Architecture of a 4-ply Wooden Transaction Card (WTC) with a Wire Embedded Booster Antenna Circuit (BAC)

The layers and process steps in the stack-up construction of the wooden transaction card (WTC/SC):

| | |
|---|---|
| CM/TCM | 6 or 8 pin faceplate transponder chip module (TCM) with a module antenna |
| | (MA) for inductive coupling with the coupler coil (CC) of an in-card booster |
| | antenna (BA) residing in a module opening (MO) or the 6 or 8 pin faceplate chip |
| | module (CM) may be galvanically connected to an in-card booster antenna (BA); |
| MA | Module antenna (MA) of the transponder chip module (TCM) having for |
| | example 15 turns for inductive coupling or bond pads of the chip module (CM) |
| | for a TeConnect interconnection; |
| | Reference is made to: internet.muehlbauer.de/products/smart-card/smart-card- |
| | production/dual-interface-card-production/mb-teconnect/ |
| MO | Module opening (MO) in the form of a stepped cavity (P₁ and P₂) to accept the |
| | insertion or implanting of the chip module (CM) or transponder chip module |
| | (TCM); |
| LM | Laser marking of personalization data to the topcoat (TC) of the upward facing |
| | (compressed) sliced wood layer (SWL) of the front single-ply wood veneer |
| | subassembly (FS); |
| AFL | |
| TC | Laser engravable topcoat (TC), sprayed-on, roller coated or screen printed, in the |
| | form of a water-based self-sealer or UV varnish to protect the underlying laser |
| | etched features; |
| AW | Artwork-laser etched graphics in the top (compressed) sliced wood layer |
| | (SWL); |
| FS | |

Front Single-Ply Wood Veneer Subassembly (FS) bonded to the Core Subassembly (CS) using
a Reinforcement Layer (RL):

| | |
|---|---|
| SWL | Top sliced wood layer (SWL: upward facing side) of the front single-ply |
| | subassembly (FS) comprising a sliced wood veneer layer orientated in a |
| | horizontal grain direction (lengthwise) having an initial thickness of 525 μm |
| | (optionally prepressed with a 50% shrinkage post compression, before final |
| | lamination of the complete stack-up assembly); |
| RL | Reinforcement layer (front) in the form of an adhesive coated substrate layer |
| | (ACSL) comprising: |
| | An adhesive layer (AL), top side of the adhesive coated substrate layer |
| | (ACSL), having a thickness of 25 μm; |
| | A substrate layer (SL) having a thickness of ~100 μm (post calendering from |
| | an initial thickness of ~220 μm), comprising a substrate of nonwoven fabric |
| | comprising cellulose (CE), synthetic fibers (SF) and a latex binder (LB); and |
| | Adhesive layer (AL), bottom side of the adhesive coated substrate layer |
| | (ACSL), having a thickness of 25 μm; |
| CS | |

Core Wood Veneer Subassembly (CS)-2-ply Subassembly (refer to FIG. 7A)

| | |
|---|---|
| WL | Intermediate wood layer (Upper PWL or IWL) of the core subassembly (CS) |
| | comprising a micro thin wood veneer (rotary peeled) orientated in a vertical grain |
| | direction (crosswise) having a thickness of 150 μm; |
| BA | An insulated wire conductor (Ø: 80 μm or 112 μm) embedded into the top |
| | adhesive layer of the adhesive coated substrate layer (ACSL) acting as a bonding |
| | layer (BL) and reinforcement layer (RL), in forming a booster antenna circuit |
| | (BAC) with a 10 turn coupler coil (CC), a 3-4 turn perimeter coil (aka |
| | communication coil) and a 4-8 turn extension coil (EC); |
| AL | Adhesive layer (top side) of the adhesive coated substrate layer (ACSL) having |
| | a thickness of 25 μm (optionally with a thickness of 35 μm or 50 μm), with the |
| | wire embedded antenna scribed therein; |
| SL | Substrate layer having a thickness of ~100 μm (post calendering from an initial |
| | thickness of ~220 μm), comprising a substrate of nonwoven fabric comprising |
| | cellulose (CE), synthetic fibers (SF) and a latex binder (LB); |
| AL | Adhesive layer (bottom side) of the adhesive coated substrate layer (ACSL) |
| | having a thickness of 25 μm (optionally with a thickness of 35 μm or 50 μm); |
| | Note that AL (top) + SL + AL (bottom) = ACSL having an overall thickness of |
| | 150 μm (may also be referred to as a reinforcement layer (RL)). |
| WL | Intermediate wood layer (Lower PWL or IWL) comprising a micro thin wood |
| | layer (WL) orientated in a horizontal or vertical grain (lengthwise or crosswise) |
| | direction having a thickness of 150 μm; |
| RS | |

Rear Single-Ply Wood Veneer Subassembly (RS) bonded together using a Reinforcement
Layer (RL):

| | |
|---|---|
| RL | Reinforcement layer (rear) in the form of an adhesive coated substrate layer |
| | (ACSL) comprising: |
| | An adhesive layer (AL), inward facing side of the rear adhesive coated |
| | substrate layer (ACSL), having a thickness of 25 μm; |
| | A substrate layer (SL) having a thickness of ~100 μm (post calendering from |
| | an initial thickness of ~220 μm), comprising a substrate of nonwoven fabric |
| | comprising cellulose (CE), synthetic fibers (SF) and a latex binder (LB); |
| | An adhesive layer (AL), downward facing bottom side of the rear adhesive |
| | coated substrate layer (ACSL), having a thickness of 25 μm; |
| SWL | Bottom sliced wood layer (SWL) of the rear single-ply subassembly (RS) |
| | comprising a sliced wood veneer layer orientated in a horizontal grain direction |
| | (lengthwise) having an initial thickness of 525 μm (optionally prepressed with |
| | 50% shrinkage post compression, before final lamination of the complete stack- |
| | up assembly); |
| ARL | |
| AW | Artwork-laser etched graphics in the bottom (compressed) sliced wood layer |
| | (SWL); |
| TC | Laser engravable topcoat (TC), sprayed on or screen printed, in the form of a |
| | water-based self-sealer or UV varnish to protect the underlying laser etched |
| | features; |
| MS | Magnetic stripe (2 or 3 tracks (HiCo)) adhesively attached to or recessed in the |
| LM | downward facing (compressed) sliced wood layer (SWL) of the rear single-ply |
| | subassembly (RS), or the magnetic stripe may be applied and pressed into the |
| | topcoat (TC); |
| | Note that the magnetic stripe (MS) may be applied directly to the rear sliced |
| | wood veneer layer (SWL) or post deposition of the artwork (AW) applied to the |
| | topcoat (TC) of UV varnish. A hologram (H) may also be hot-stamped to the |
| | topcoat (TC). |
| | Laser marking (LM) of personalization data to the topcoat (TC) in downward |
| | facing (compressed) sliced wood layer (SWL) of the rear single-ply subassembly |
| | (RS); |

Security elements (not shown)—signature panel and payment brand hologram.

Note that the top sliced wood layer (SWL: upward facing side) of the front single-ply subassembly (FS) and the bottom sliced wood layer (SWL) of the rear single-ply subassembly (RS), with each layer comprising a sliced wood veneer layer orientated in a horizontal grain direction (lengthwise) having a thickness of 525 μm may not be prepressed, but rather laminated in a final lamination step to the core (laminated) subassembly (CS). During the final lamination step to the core (laminated) subassembly (CS) using upper and lower adhesive coated substrate layers (reinforcement layers (RL)) for bonding and reinforcement, the sliced wood layers shrink significantly in the compression lamination process.

FIG. 7C: Description and dimensions of the individual layers forming the smartcard (SC) construction.

| Layers | Description | Grain direction | Thickness |
|---|---|---|---|
| SWL-FS | Sliced wood (veneer) layer (Top)-wood | Lengthwise | 525 μm |
| | species: Maple (Optionally, 50% Compression | | |
| | in Prepress) | | |
| RL-FS | Reinforcement layer for bonding and rigidity | | 150 μm |
| WL-CS | Intermediate (rotary) peeled wood (veneer) layer | Crosswise | 150 μm |
| | (PWL: Upper Core)-wood species: Birch | | |
| BA-CS | Wire embedded booster antenna circuit (BAC) | | |
| | formed in the top adhesive layer coated to the | | |
| | substrate layer and completely submerged (bare | | |
| | copper wire Ø 80 μm or Ø 112 μm | | |
| AL-CS | Top adhesive layer of the adhesive coated | | 25 μm |
| | substrate layer (ACSL) for bonding, and to | | |
| | accept the ultrasonic scribing of the wire antenna | | |
| | circuit, optionally 35 or 50 μm | | |
| SL-CS | Substrate layer in the form of a nonwoven fabric | | 100 μm |
| | (comprising cellulose and synthetic fibers in a | | |
| | latex binder) for reinforcement | | |
| AL-CS | Bottom adhesive layer of the adhesive coated | | 25 μm |
| | substrate layer (ACSL) for bonding, optionally | | |
| | 35 or 50 μm | | |
| WL-CS | Intermediate (rotary) peeled wood (veneer) layer | Crosswise | 150 μm |
| | (PWL: Lower Core)-wood species: Birch | | |
| RL-RS | Reinforcement layer for bonding and rigidity | | 150 μm |
| SWL-RS | Sliced wood (veneer) layer (Bottom)-wood | Lengthwise | 525 μm |
| | species: Maple (Optionally, 50% Compression | | |
| | in Prepress) | | |
| | Total thickness of the 4-ply construction with | | 1.80 mm |
| | 3 inner layers of reinforcement (ACSL) before | | |
| | lamination: | | |
| | Post lamination of the assembly with 50% | | |
| | shrinkage of the Sliced Wood Layers (SWLs), | | |
| | shrinkage of the Intermediate Wood Layers | | |
| | (IWLs, PWLs), and compression of the adhesive | | |
| | coated substrate layers (ACSLs) with a | | |
| | shrinkage of 75%, resulting in a card body | | |
| | thickness: ~0.820 mm | | |

### Impregnation/Topcoat—Laser Etched Artwork

### Additional Front Layers (AFL)

| Layers | Description | | Thickness |
|---|---|---|---|
| TC | Laser engravable topcoat (TC)- | Water-based | 10 μm |
| | sprayed on or screen printed, for | self-sealer/ | |
| | impregnation post laser treatment | UV varnish | |
| AW | Laser-etched Artwork | | |

### Additional Rear Layers (ARL)

| Layers | Description | | Thickness |
|---|---|---|---|
| AW | Laser-etched Artwork | | |
| TC | Laser engravable topcoat (TC)- | Water-based | 10 μm |
| | sprayed on or screen printed, for | self-sealer/ | |
| | impregnation post laser treatment | UV varnish | |

An adhesive coated substrate layer (ACSL) receives an antenna circuit, by scribing an insulated copper wire into the top adhesive layer in forming an antenna circuit using an ultrasonic wire embedding tool (sonotrode), with the wire conductor submerged or countersunk in the adhesive coating with no protrusion on its surface. Post-embedding, the adhesive coated substrate layer (ACSL) may be pressed in a laminator to enhance the fixation of the wire antenna circuit(s).

The ultrasonic wire embedding of the insulated copper wire may be performed directly into the adhesive coated substrate layer (ACSL) in forming the antenna circuit. The copper wire may be a self-bonding wire. Self-bonding enameled wire (SB-wire), also referred to as bondable magnet wire, is film insulated wire which is coated with an additional bonding adhesive. Optionally, the thickness of the adhesive coating on the insulated copper wire can be increased to facilitate the wire embedding process.

The layer of adhesive coated substrate layer (ACSL) with a wire embedded antenna adhesively bonds together in a lamination process the upper and lower layers of wood veneer to form the core subassembly (CS), as shown in FIG. 7A. The adhesive coating (on both sides of the substrate layer (SL)) being a bonding agent for the upper and lower layers of (rotary peeled) wood veneer.

The outer wood layers (front and rear) may be sliced wood veneers with an initial thickness of 525 μm and compressed during the lamination process, while the intermediate wood layers may be rotary peeled micro-thin wood veneers with an initial thickness of 150 μm.

In a two-step lamination process, with pre-lamination of the core subassembly (CS) under controlled temperature (hot: 135° C. to 150° C. and cold: 20° C. and pressure: 150 N/cm²), the complete card body subassembly (CBS) has an overall thickness of 1800 μm before lamination, front subassembly (FS): SWL/525 μm and RL/150 μm; core subassembly (CS) including the booster antenna circuit (BAC): PWL/150 μm, ACSL/150 μm (AL/25 μm+SL/100 μm+AL/25 μm) and PWL/150 μm; and the rear subassembly (RS): RL/150 μm and SWL/525 μm, and post lamination of the assembly (hot: 135° C. to 150° C. and cold: 20° C. and pressure: 200 to 850 N/cm²) the thickness is approximately 820 μm, before application of the impregnation layers and topcoats.

FIG. 7D shows an embodiment of a construction of a smartcard. The smartcard comprises a 5-ply card body subassembly (CBS). The front and rear subassemblies (FS and RS, respectively) and the core subassembly (CS) are shown for context. In this, and in some other figures, the chip module (TCM), additional front layers (AFL), additional rear layers (ARL, and magnetic stripe (MS) are omitted, for illustrative clarity.

The booster antenna BA may be embedded, such as by scribing, into the adhesive layer on the top (front) surface of the first adhesive coated substrate layer (ACSL=AL+SL+AL) in the core subassembly.

FIG. 7D: Architecture of a 5-ply Wooden Transaction Card (WTC) with a Wire Embedded Booster Antenna Circuit (BAC)—(CM/TCM, AFL, MS, ARL omitted)

The layers and process steps in the stack-up construction of the wooden transaction card (WTC/SC):

FS

Front Single-Ply Wood Veneer Subassembly (FS) bonded to the Core Subassembly (CS) using
an Adhesive Coated Substrate Layer (ACSL):

| | |
|---|---|
| PWL | Front (top) wood layer (WL or PWL: upward facing side) of the front single-ply |
| | subassembly (FS) comprising a rotary peeled wood veneer layer orientated in a |
| | horizontal grain direction (lengthwise) having a thickness of 150 μm; |
| AL | Adhesive layer of the adhesive coated substrate layer (ACSL) functioning as a |
| | bonding layer (BL) having a thickness of 25 μm; |
| SL | Substrate layer having a thickness of ~100 μm (post calendering from an initial |
| | thickness of ~220 μm) functioning as a reinforcement layer (RL), comprising a |
| | substrate layer of nonwoven fabric comprising cellulose (CE), synthetic fibers |
| | (SF) and a latex binder (LB); |
| AL | Adhesive layer of the adhesive coated substrate layer (ACSL) functioning as a |
| | bonding layer (BL) having a thickness of 25 μm; |
| | Note that AL + SL + AL = ACSL having an overall thickness of 150 μm, may |
| | also be referred to as a reinforcement layer (RL). |
| CS | |

Core Wood Veneer Subassembly (CS)-3-ply Subassembly (refer to FIG. 7B)

| | |
|---|---|
| WL | Intermediate wood layer (Upper PWL or IWL) of the core subassembly (CS) |
| | comprising a micro thin wood veneer (rotary peeled) orientated in a vertical grain |
| | direction (crosswise) having a thickness of 150 μm; |
| BA | An insulated wire conductor (Ø: 80 μm or 112 μm) embedded into the top |
| | adhesive layer of the adhesive coated substrate layer (ACSL) acting as a bonding |
| | layer (BL) and reinforcement layer (RL), in forming a booster antenna (BA) or |
| | a booster antenna circuit (BAC) with a coupler coil (CC), a perimeter coil (aka |
| | communication coil) and an extension coil (EA); |
| AL | Adhesive layer (top side) of the adhesive coated substrate layer (ACSL) having |
| | a thickness of 25 μm, with the wire embedded antenna scribed therein; |
| SL | Substrate layer having a thickness of ~100 μm (post calendering from an initial |
| | thickness of ~220 μm), comprising a substrate layer of nonwoven fabric |
| | comprising cellulose (CE), synthetic fibers (SF) and a latex binder (LB); |
| AL | Adhesive layer (bottom side) of the adhesive coated substrate layer (ACSL) |
| | having a thickness of 25 μm; |
| | Note that AL + SL + AL = ACSL having an overall thickness of 150 μm, may |
| | also be referred to as a reinforcement layer (RL). |
| WL | Intermediate wood layer (Middle PWL or IWL) comprising a micro thin wood |
| | layer (WL) orientated in a horizontal or vertical grain (lengthwise or crosswise) |
| | direction having a thickness of 150 μm; |
| AL | Adhesive layer (top side) of the adhesive coated substrate layer (ACSL) having |
| | a thickness of 25 μm; |
| SL | Substrate layer having a thickness of ~100 μm (post calendering from an initial |
| | thickness of ~220 μm), comprising a substrate layer of nonwoven fabric |
| | comprising cellulose (CE), synthetic fibers (SF) and a latex binder (LB); |
| AL | Adhesive layer (bottom side) of the adhesive coated substrate layer (ACSL) |
| | having a thickness of 25 μm; |
| | Note that AL + SL + AL = ACSL having an overall thickness of 150 μm, may |
| | also be referred to as a reinforcement layer (RL). |
| WL | Intermediate wood layer (Lower PWL or IWL) comprising a micro thin wood |
| | layer (WL) orientated in a vertical grain (crosswise) direction having a thickness |
| | of 150 μm; |
| RS | |

Rear Single-Ply Wood Veneer Subassembly (RS) bonded together using an Adhesive Coated
Substrate Layer (ACSL):

| | |
|---|---|
| AL | Adhesive layer of the adhesive coated substrate layer (ACSL) functioning as a |
| | bonding layer (BL) having a thickness of 25 μm; |
| SL | Substrate layer having a thickness of ~100 μm (post calendering from an initial |
| | thickness of ~220 μm) functioning as a reinforcement layer (RL), comprising a |
| | substrate layer of nonwoven fabric comprising cellulose (CE), synthetic fibers |
| | (SF) and a latex binder (LB); |
| AL | Adhesive layer of the adhesive coated substrate layer (ACSL) functioning as a |
| | bonding layer (BL) having a thickness of 25 μm; |
| PWL | Note that AL + SL + AL = ACSL having an overall thickness of 150 μm, may |
| | also be referred to as a reinforcement layer (RL). |
| | Rear (outer) wood layer (WL or PWL: downward facing side) of the rear single- |
| | ply subassembly (FS) comprising a rotary peeled wood veneer layer orientated |
| | in a horizontal grain direction (lengthwise) having a thickness of 150 μm; |

Security elements (not shown)—signature panel and payment brand hologram.

In a two-step lamination process, with pre-lamination of the core subassembly (CS) under controlled temperature (hot: 135° C. to 150° C. and cold: 20° C. and pressure: 150 N/cm²), the complete card body subassembly (CBS) has an overall thickness of 1350 μm before lamination, front subassembly (FS): PWL/150 μm+ACSL/150 μm (AL/25 μm+SL/100 μm+AL/25 μm); core subassembly (CS) including the booster antenna circuit (BAC): PWL/150 μm, ACSL/150 μm (AL/25 μm+SL/100 μm+AL/25 μm), PWL/150 μm, ACSL/150 μm (AL/25 μm+SL/100 μm+AL/25 μm) and PWL/150 μm; and the rear subassembly (RS): ACSL/150 μm (AL/25 μm+SL/100 μm+AL/25 μm) and PWL/150 μm, and post lamination of the assembly (hot: 135° C. to 150° C. and cold: 20° C. and pressure: 200 to 850 N/cm²) the thickness is approximately 760 μm, before application of impregnation layers and topcoats.

Rotary peeled or sliced wood veneers are preconditioned (dried at the mill) with a moisture content in the range of 6% to 9%. As a further embodiment of the invention, a laminated sheet assembly (LSA), a stack-up construction, having a plurality of card body sites for production of a like plurality of smart cards (SC), said laminated sheet assembly (LSA) having a front (top) exposed surface and a rear (bottom) exposed surface, and said laminated sheet assembly (LSA) having a core subassembly (CS) comprising (pre-conditioned) two or three layers of micro thin rotary peeled wood veneer layers (WL, PWL) with each wood layer (WL) having a thickness of 150 μm sandwiching an adhesive coated substrate layer (AL (~25 μm)+SL (~100 μm (post calendering from an initial thickness of ~220 μm))+AL (~25 μm)=ACSL) with a thickness of 150 μm comprising a substrate layer (SL) of wetlaid nonwoven fabric (cellulose and synthetic fibers bonded with a latex binder) coated on both sides (top and bottom) with a thermoplastic (PVAc) adhesive layer (AL) wherein a booster antenna (BA) or aa booster antenna circuit (BAC) is incorporated into the top adhesive layer (AL) of said adhesive coated substrate layer (ACSL); Optionally pre-laminating the core subassembly (CS), a 2 or 3-ply subassembly sandwiching a booster antenna circuit (BAC) integrated into an adhesive layer (AL) of the adhesive coated substrate layer (ACSL) at a lamination pressure in the range of 150-200 N/cm² and at a temperature of 140° C. for a dwell time of 6 minutes; said laminated sheet assembly (LSA) produced by forming a final stack-up assembly of (preconditioned) outer (exposed) layers (front and rear) of wood veneer, rotary peeled (WL, PWL with a thickness of 150 μm) or sliced (WL, SWL with a thickness of 525 μm), with said wood layers (WL) having a moisture content in the range of 6% to 9%, and the stack-up assembly further having inner intermediate layers (top and bottom) of adhesive coated substrate layers (ACSL) with each ACSL layer having a thickness of 150 μm sandwiching the core subassembly (CS); laminating the complete stack-up assembly (front WL+top ACSL+CS (2 or 3 ply construction with integrated BAC)+bottom ACSL+rear WL) in a single step using a pressure between 200 N/cm² and 850 N/cm² at a temperature between 135° C. and 150° C. for a dwell time between 30 and 50 minutes followed by a cooling cycle to ambient pressure and temperature, in compressing the final stack-up assembly to an ISO conforming thickness of 800 μm; and post lamination of the complete assembly, coating the exposed surfaces with a primer for the purpose of impregnation (waterproofing) and surface treatment (adhesion promoter).

FIG. 7E shows a laminated sheet assembly (stack-up, construction) in a 5×5 format having a plurality of card body sites for production of a like plurality of smart cards, said laminated sheet having a front (top) exposed surface and a rear (bottom) exposed surface, said laminated sheet assembly comprising 5 wood veneer layers and 4 adhesive coated substrate layers.

FIG. 7E: Description and dimensions of the individual layers of the laminated sheet assembly (LSA) comprising 5 wood veneer layers (WL) and 4 adhesive coated substrate layers (ACSL).

### Front Subassembly (FS)

| | | Grain | |
|---|---|---|---|
| Layers | Description | direction | Thickness |
| WL-FS | Front sheet of rotary peeled | Lengthwise | 150 μm |
| | wood (veneer) layer | | |
| | (WL, PWL) | | |
| ACSL-FS | Adhesive coated substrate | | 150 μm |
| | layer (ACSL) or | | |
| | reinforcement layer (RL) for | | |
| | bonding and reinforcement | | |

### Core Subassembly (CS)

| Layers | Description | Grain direction | Thickness |
|---|---|---|---|
| WL-CS | Top sheet of rotary peeled wood (veneer) layer | Crosswise | 150 μm |
| | (WL, PWL)-3-ply core subassembly (CS) | | |
| BA-CS | Array of wire embedded booster antenna circuits | | N/A |
| | (BAC) formed in the adhesive coated substrate | | |
| | layer (ACSL) | | |
| ACSL- | Adhesive coated substrate layer (ACSL) or | | 150 μm |
| CS | reinforcement layer (RL) for bonding, | | |
| | reinforcement and to accept the integration of | | |
| | the array of wire embedded antennae | | |
| WL-CS | Intermediate sheet of rotary peeled wood | Lengthwise or | 150 μm |
| | (veneer) layer (WL, PWL) | Crosswise | |
| ACSL- | Adhesive coated substrate layer (ACSL) or | | 150 μm |
| CS | reinforcement layer (RL) for bonding and | | |
| | reinforcement | | |
| WL-CS | Bottom sheet of rotary peeled wood (veneer) | Crosswise | 150 μm |
| | layer (WL, PWL)-3-ply core subassembly (CS) | | |

### Rear Subassembly (RS)

| Layers | Description | Grain direction | Thickness |
|---|---|---|---|
| ACSL- | Adhesive coated substrate layer (ACSL) or | | 150 μm |
| RS | reinforcement layer (RL) for bonding and | | |
| | reinforcement | | |
| WL-RS | Rear sheet of rotary peeled wood (veneer) layer | Lengthwise | 150 μm |
| | (WL, PWL) | | |
| | Total thickness of the 5-ply construction with | | 1,350 μm |
| | 4 inner layers of ACSL before lamination: | | |
| | Post lamination thickness of the assembly with | | 0.760- |
| | ~40% shrinkage in thickness: | | 0.800 mm |

Note that the reinforcement layers (ACSL or RL) comprise a substrate layer (SL) of nonwoven fabric, nonwoven pulp and fiber or nonwoven fluff pulp (further comprising cellulose, synthetic and organic fibers bonded with a latex binder) coated on both sides by way of adhesive transfer, spray coating or curtain coating with a thermoplastic adhesive (PVAc) having a total thickness of 150 μm, and laid in a specific direction (lengthwise (horizontal) or crosswise (vertical)) relative to the wood veneer layers.

FIG. 7F shows a laminated sheet assembly (LSA; stack-up, construction) in a 3×8 format having a plurality of card body sites for production of a like plurality of smart cards, said laminated sheet having a front (top) exposed surface and a rear (bottom) exposed surface, said laminated sheet assembly comprising 4 wood veneer layers and 3 adhesive coated substrate layers.

FIG. 7F: Description and dimensions of the laminated sheet assembly (LSA) comprising 4 wood veneer layers (WL) and 3 adhesive coated substrate layers (ACSL).

### Front Subassembly (FS)

| Layers | Description | Grain direction | Thickness |
|---|---|---|---|
| SWL-FS | Front sheet of sliced wood (veneer) layer | Lengthwise | 525 μm |
| | (WL, SWL)-wood species: maple | | |
| ACSL-FS | Adhesive coated substrate layer (ACSL) | | 150 μm |
| | orr einforcement layer (RL) for bonding | | |
| | and rigidity | | |

### Core Subassembly (CS)

| Layers | Description | Grain direction | Thickness |
|---|---|---|---|
| WL-CS | Top sheet of rotary peeled wood (veneer) layer | Crosswise | 150 μm |
| | (WL, PWL)-wood species: birch-2-ply core | | |
| | subassembly (CS) | | |
| BA-CS | Array of wire embedded booster antenna | | |
| | circuits (BAC) formed in the top adhesive layer | | |
| | (AL) of the adhesive coated substrate layer | | |
| | (ACSL) and completely submerged (bare | | |
| | copper wire Ø 80 μm or Ø 112 μm | | |
| AL/ACSL- | Top adhesive layer (AL) of the adhesive coated | | 25 μm |
| CS | substrate layer (ACSL) for bonding, and to | | |
| | accept the ultrasonic scribing of the array of | | |
| | wire antenna circuits | | |
| SL-CS | Substrate layer in the form of a nonwoven | | 100 μm |
| | fabric (comprising cellulose and synthetic | | |
| | fibers bonded in a latex binder) for | | |
| | reinforcement | | |
| AL/ACSL- | Bottom adhesive layer (AL) of the adhesive | | 25 μm |
| CS | coated substrate layer (ACSL) for bonding | | |
| WL-CS | Bottom sheet of rotary peeled wood (veneer) | Crosswise | 150 μm |
| | layer (WL, PWL)-wood species: birch-2-ply | | |
| | core subassembly (CS) | | |

### Rear Subassembly (RS)

| Layers | Description | Grain direction | Thickness |
|---|---|---|---|
| ACSL-RS | Adhesive coated substrate layer (ACSL) or | | 150 μm |
| | reinforcement layer (RL) for bonding and | | |
| | rigidity | | |
| SWL-RS | Rear sheet of sliced wood (veneer) layer | Lengthwise | 525 μm |
| | (WL, SWL)-wood species: maple | | |
| | Total thickness of the 4-ply construction with | | 1,800 μm |
| | 3 inner layers of reinforcement (ACSL) before | | |
| | lamination: | | |
| | Post lamination thickness of the assembly with | | 0.760- |
| | ~55% shrinkage in thickness: | | 0.800 mm |

A highly compressed laminated sheet assembly (LSA) has multiple wood veneer layers (e.g. 5 layers), adhesive coated substrate layers (ACSL) as interlayers (e.g. 4 layers) for bonding and reinforcement, an array of card body sites (SCB) in a production format (e.g. 3×8 (24-up), 5×5 (25-up), 6×8 (48-up), etc.) incorporating a booster antenna circuit (BAC) at each card body position, and the sheet assembly having a top and bottom exposed surface (front and rear face) coated with a primer (post lamination) for impregnation (waterproofing) and surface treatment (adhesion promoter) to receive the later deposition of digital ink.

The wood veneer layers (WL) may be micro thin rotary peeled wood veneer (PWL e.g. birch) each having a thickness of 150 μm (preconditioned (drying process) at the mill with a moisture content in the range of 6 to 9 percent) and the adhesive coated substrate layers (ACSL) each having a thickness of 150 μm comprising a wetlaid nonwoven fabric (~100 μm (post calendering from an initial thickness of ~220 μm)) coated on both sides with a thermoplastic adhesive (~25 μm) such as PVAc with the nonwoven fabric comprising cellulose and synthetic fibers (e.g. polyester fibers) bonded with a latex binder.

The array of booster antenna circuits (BAC) formed by wire embedding into an adhesive coated substrate layer (ACSL) using multiple ultrasonic tools (aka sonotrodes). Said adhesive coated substrate layer (ACSL) incorporating the array of booster antenna circuits (BAC) may be laminated between layers of wood veneer to form a core subassembly (CS: 3-ply construction) before final lamination of the complete stack-up.

The total thickness of the individual layers forming the assembly (5 wood veneer layers and 4 adhesive coated substrate layers) before press lamination may be approximately 1350 μm. The post lamination thickness of the laminated sheet assembly (LSA) may be approximately 800 μm, representing a shrinkage of approximately 40%.

The post laminated assembly may be a solid homogenous sheet which cannot be delaminated to reveal individual layers, achieved through the composition of material layers of micro thin wood veneer (e.g. 5 layers), wetlaid nonwoven fabric (e.g. 4 substrate layers for reinforcement) and adhesive (e.g. 8 coating layers) forming the stack-up and the compression process of laminating in multiple steps with defined lamination parameters.

The lamination parameters of the 3-ply core subassembly may for example be 15 kg per cm² of pressure at a temperature of 140° C. for a dwell time of 6 minutes. This equates to 147 N/cm² across an area of 360 mm×605 mm (e.g. 3×8 format), representing 32.7 tons of pressure. The final lamination step of the complete stack-up may be a single continuous lamination process (linear, gradual (curved) or exponential) using a pressure between 200 N/cm² and 850 N/cm² at a temperature between 135° C. and 150° C. for a dwell time between 30 and 50 minutes followed by a cooling cycle to ambient pressure and temperature, depending on the type and thickness of wood species in the stack-up construction of the assembly (and the number of stacked assemblies in the lamination press).

Post lamination, the laminated sheet assembly (LSA) may receive magnetic stripes (MS). Post lamination, the laminated sheet assembly (LSA) may also receive a milled-out pocket (stepped recess (P1 and P2) to accept the later implanting of a chip module (CM)) at each card body site (CBS) in the array, simplifying the production at the smartcard manufacturer. The milled-out pocket may have a surface roughness (Ra) of approximately 6 μm. Index holes and or fiducials may be provided for later alignment of the laminated sheet assembly (LSA). In reducing the laminated sheet assembly (LSA) to card bodies (singulation process), the sheets may be CO₂ laser cut, punched or milled.

The resultant card bodies may be completely flat (without warpage) with a defined stiffness, breakage point and a weight of approximately 4 grams. See, for example, FIG. 7E.

To increase the weight of the individual card bodies (CB), the stack-up construction may be modified. The stack-up assembly may comprise two layers (front and rear) of sliced wood veneer (WL, SWL e.g. maple) with each wood layer (WL) having an initial thickness of approximately 525 μm and two layers of micro thin rotary peeled wood veneer (WL, PWL) with an initial thickness of 150 μm and three adhesive coated substrate layers (ACSL) as interlayers for bonding and reinforcement with an initial thickness of 150 μm. The total thickness of the assembly before lamination may be 1800 μm. The post lamination thickness of the assembly may be approximately 800 μm, representing a shrinkage of approximately 55%. The central adhesive coated substrate layer (ACSL) incorporating the array of booster antenna circuits (BAC) may be laminated between the two layers (upper and lower) of rotating peeled wood veneer (WL, PWL) to form a core subassembly (2-ply construction) before final lamination of the complete stack-up. See, for example, FIG. 7F.

FIG. 8 shows a construction of a 5-ply wooden transaction card (WTC) having a booster antenna (BA) incorporated into an adhesive coated substrate layer (ACSL) in the core subassembly.

FIG. 8: Architecture of a 5-ply Wooden Transaction Card (WTC) with a Wire Embedded Booster Antenna Circuit (BAC)

The layers and process steps in the stack-up construction of the wooden transaction card
(WTC/SC):

| | |
|---|---|
| TCM | 6 or 8 pin faceplate transponder chip module with a module antenna (MA) for inductive |
| | coupling with the coupler coil (CC) of an in-card booster antenna (BA) residing in a |
| | module opening (MO)-not shown; |
| MA | Module antenna (MA) of the transponder chip module (TCM) having for example 15 |
| | turns-not shown; |
| MO | Module opening (MO) in the form of a stepped cavity (P₁ and P₂) to accept the insertion |
| | or implanting of the transponder chip module (TCM)-not shown; |
| LM | Laser marking of personalization data to the topcoat (TC) of the upward facing wood |
| | layer (WL) of the front 2-ply wood veneer subassembly (FS)-not shown; |
| AFL | |
| TC | Laser engravable topcoat (TC), sprayed-on, roller coated or screen printed, in the form |
| | of a water-based self-sealer or UV varnish to protect the digitally deposited UV curable |
| | ink; |
| AW | Artwork-digitally deposited UV curable ink (including a white channel as undercoat) |
| | directly onto the front face surface of the wood layer (WL) or to the impregnation layer |
| | (IL) acting as an adhesion promoter (primer); |
| IL | Optional, an Impregnation Layer (IL)-(Waterproofing/Reinforcement/Adhesion |
| | Promoter)-application of a water-based self-sealer or primer by spraying, coating or |
| | screen printing to the surface of the wood layer (WL) in the front two-ply subassembly |
| | (FS); |
| | Features may be mechanically engraved or laser etched before application of the topcoat |
| | (TC) to the front wood layer (upward facing side) of the front 2-ply wood veneer |
| | subassembly (FS). The topcoat may be a digitally deposited varnish (gloss or matt). |
| FS | |

Front 2-Ply Wood Veneer Subassembly (FS) bonded together using an Adhesive Coated
Substrate Layer (ACSL) as a Bonding and Reinforcement Layer

| | |
|---|---|
| WL | Top wood layer (WL: upward facing side) of the front 2-ply subassembly (FS) |
| | comprising a micro thin wood veneer orientated in a horizontal grain direction |
| | (lengthwise) having a thickness of 150 μm; |
| RL | Reinforcement layer (RL) in the form of an adhesive coated substrate layer (ACSL) |
| | having a thickness of 150 μm with a processing temperature of 120-140° C., comprising |
| | a substrate of nonwoven fabric (cellulose (CE) and synthetic fibers (SF) in a latex binder |
| | (LB) coated on both sides with an adhesive layer (AL), wherein the adhesive on both |
| | sides of the substrate layer (SL) impregnates the underside of the top wood layer (WL) |
| | and the upside of the underlying (bottom layer) wood layer (WL); |
| WL | Bottom wood layer (WL) of the front 2-ply subassembly (FS) comprising a micro thin |
| | wood veneer orientated in a vertical grain direction (crosswise) having a thickness of |
| | 150 μm; |
| CS | |

Core Subassembly (CS)

| | |
|---|---|
| BA | An insulated wire conductor (Ø: 80 μm or 112 μm) embedded into the top adhesive |
| | coating of the adhesive coated substrate layer (ACSL) acting as a bonding and |
| | reinforcement layer (RL), in forming a booster antenna (BA) with a coupler coil (CC), |
| | a perimeter coil and an extension coil; |
| RL | Reinforcement layer (RL) in the form of an adhesive coated substrate layer (ACSL) |
| | having a thickness of 150 μm with a processing temperature of 120-140° C., comprising |
| | a substrate of nonwoven fabric (cellulose (CE) and synthetic fibers (SF) in a latex binder |
| | (LB) coated on both sides with an adhesive layer (AL), wherein the adhesive on both |
| | sides of the substrate layer (SL) impregnates the upside of the core wood layer (WL) |
| | and the underside of the wood layer (WL) in the front subassembly (FS); |
| WL | A micro thin wood layer (WL) orientated in a horizontal or vertical grain (lengthwise or |
| | crosswise) direction having a thickness of 150 μm; |
| RL | Reinforcement layer (RL) in the form of an adhesive coated substrate layer (ACSL) |
| | having a thickness of 150 μm with a processing temperature of 120-140° C., comprising |
| | a substrate of nonwoven fabric (cellulose (CE) and synthetic fibers (SF) in a latex binder |
| | (LB) coated on both sides with an adhesive layer (AL), wherein the adhesive on both |
| | sides of the substrate layer (SL) impregnates the underside of the core wood layer (WL) |
| | and the upside of the wood layer (WL) in the rear subassembly (RS); |
| RS | |

Rear 2-Ply Wood Veneer Subassembly (RS) bonded together using an Adhesive Coated
Substrate Layer (ACSL)

| | |
|---|---|
| WL | Bottom wood layer (WL) of the rear 2-ply subassembly (RS) comprising a micro thin |
| | wood veneer orientated in a vertical grain direction (crosswise) having a thickness of |
| | 150 μm; |
| RL | Reinforcement layer (RL) in the form of an adhesive coated substrate layer (ACSL) |
| | having a thickness of 150 μm with a processing temperature of 120-140° C., comprising |
| | a substrate of nonwoven fabric (cellulose (CE) and synthetic fibers (SF) in a latex binder |
| | (LB) coated on both sides with an adhesive layer (AL), wherein the adhesive on both |
| | sides of the substrate layer (SL) impregnates the underside of the bottom wood layer |
| | (WL) and the upside of the rear downward facing wood layer (WL); |
| WL | Front wood layer (WL: downward facing side) of the rear 2-ply subassembly (RS) |
| | comprising a micro thin wood veneer orientated in a horizontal grain direction |
| | (lengthwise) having a thickness of 150 μm; |
| | Features may be mechanically engraved or laser etched before application of the topcoat |
| | (TC) to the front wood layer (WL: downward facing side) of the rear 2-ply subassembly |
| | (RS). |
| ARL | |
| IL | Optional, an Impregnation Layer (IL)-(Waterproofing/Reinforcement/Adhesion |
| | Promoter)-application of a water-based self-sealer or primer by spraying, coating or |
| | screen printing to the front face surface of the wood layer (WL) in the rear 2-ply |
| | subassembly (RS); |
| AW | Artwork-digitally deposited UV curable ink (including a white channel as undercoat) |
| | directly onto the surface of the downward facing wood layer (WL) or to the |
| | impregnation layer (IL) acting as an adhesion promoter (primer); |
| TC | Laser engravable topcoat (TC), sprayed on, roller coated or screen printed, in the form |
| | of a water-based self-sealer or UV varnish to protect the digitally deposited UV curable |
| | ink; |
| MS | Magnetic stripe (2 or 3 tracks (HiCo)) adhesively attached to or recessed in the |
| | downward facing wood layer (WL) of the rear 2-ply subassembly (RS), or the magnetic |
| | stripe may be applied and pressed into the topcoat (TC); |
| | Note the magnetic stripe (MS) may be applied directly to the rear sliced wood veneer |
| | (SWL) or post deposition of the artwork (AW) applied to the topcoat (TC) of UV |
| | varnish. A hologram (H) may also be hot-stamped to the topcoat (TC). |
| LM | Laser marking (LM) of personalization data to the topcoat (TC) in the form of a water- |
| | based self-sealer or UV varnish in downward facing wood layer (WL) of the rear 2-ply |
| | subassembly (RS)-not shown; |

Security elements (not shown)—signature panel and payment brand hologram.

FIG. 8: Description and dimensions of the individual layers forming the smartcard (SC) construction.

| Layers | Description | Grain direction | Thickness |
|---|---|---|---|
| WL-FS | Rotary peeled wood (veneer) layer (Top) | Lengthwise | 150 μm |
| RL-FS | Adhesive coated substrate layer (ACSL) for | | 150 μm |
| | bonding and reinforcement | | |
| WL-FS | Rotary peeled wood (veneer) layer (Bottom) | Crosswise | 150 μm |
| BA-CS | Wire embedded booster antenna circuit (BAC) | | N/A |
| | formed in the adhesive coated substrate layer | | |
| | (ACSL) | | |
| RL-CS | Adhesive coated substrate layer (ACSL) for | | 150 μm |
| | bonding, reinforcement and to accept the | | |
| | integration of the wire embedded antenna | | |
| WL-CS | Rotary peeled wood (veneer) layer (Core) | Lengthwise or | 150 μm |
| | | Crosswise | |
| RL-CS | Adhesive coated substrate layer (ACSL) for | | 150 μm |
| | bonding and reinforcement | | |
| WL-RS | Rotary peeled wood (veneer) layer (Bottom- | Crosswise | 150 μm |
| | inward facing side) | | |
| RL-RS | Adhesive coated substrate layer (ACSL) for | | 150 μm |
| | bonding and reinforcement | | |
| WL-RS | Rotary peeled wood (veneer) layer (Front- | Lengthwise | 150 μm |
| | downward facing side) | | |
| | Total thickness of the 5-ply construction with | | 1.350 mm |
| | 4 inner layers of ACSL before lamination: | | |
| | Post lamination thickness of the assembly with | | 0.875 mm |
| | 35% shrinkage in thickness: | | |

### Impregnation—Artwork—Topcoat

### Additional Front Layers (AFL)

| Layers | Description | | Thickness |
|---|---|---|---|
| TC | Laser engravable topcoat (TC)- | Water-based self-sealer/ | |
| | sprayed on, roller coated or | UV varnish | |
| | screen printed | | |
| AW | Artwork-digitally deposited | UV curable Ink | |
| IL | Optional, impregnation layer/ | Water-based self-sealer/ | |
| | Adhesion promoter-spraying/ | primer | |
| | screen printing | | |
| | | Thickness before | ~45 μm |
| | | absorption into the wood | |
| | | veneer | |

### Additional Rear Layers (ARL)

| Layers | Description | | Thickness |
|---|---|---|---|
| IL | Optional, Impregnation layer/ | Water-based self-sealer/ | |
| | Adhesion promoter-spraying/ | primer | |
| | screen printing | | |
| AW | Artwork-digitally deposited | UV curable Ink | |
| TC | Laser engravable topcoat (TC)- | Water-based self-sealer/ | |
| | sprayed on, roller coated or | UV varnish | |
| | screen printed | | |
| | | Thickness before | ~45 μm |
| | | absorption into the wood | |
| | | veneer | |

Bio-based and bio-inspired adhesives from animals and plants may replace conventional petrochemical adhesives used for bonding of the wood layers.

In a one-step lamination process, the complete card body subassembly (CBS) has an overall thickness of 1350 μm pre-lamination (front subassembly (FS): WL/150 μm+ACSL/150 μm+WL/150 μm; core subassembly (CS) including the booster antenna circuit (BAC): ACSL/150 μm+WL/150 μm+ACSL/150 μm; and the rear subassembly (RS): WL/150 μm+ACSL/150 μm+WL/150 μm) and post lamination (hot: 135° C. to 150° C. and cold: 20° C. and pressure: 150 N/cm²) the thickness is approximately 875 μm, representing a shrinkage in thickness of 35%. In a further process step, the laminated assembly is sanded-back on both sides to achieve an ISO compliant thickness of approximately 800 μm.

By doubling the lamination pressure from 150 N/cm² to 300 N/cm², a final lamination thickness of 800 μm can be achieved, avoiding the process of sanding back.

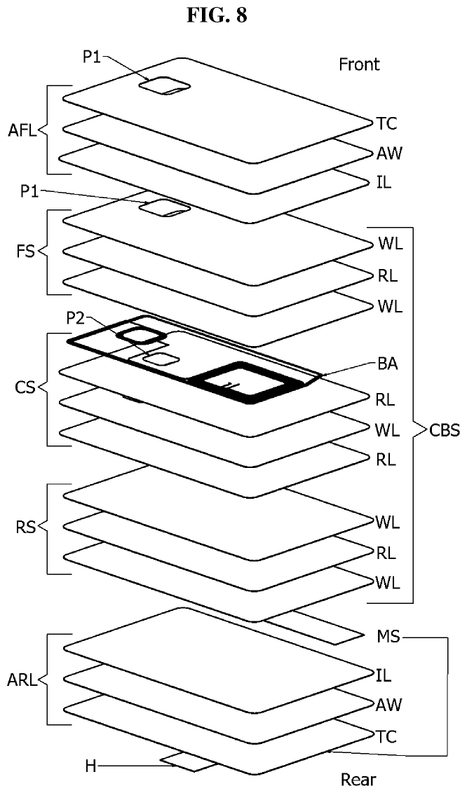

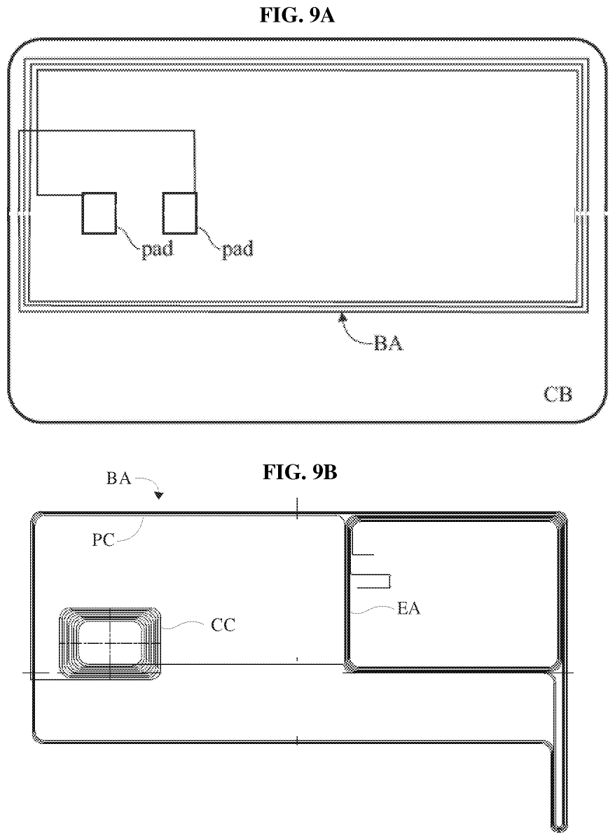

FIG. 9A shows a wire-embedded booster antenna (BA) for a smartcard (SC) having landing pads (labeled “pad”) in the form of meandering embedded wire also referred to as wire squiggles. A physical interconnection is made between the wire meandering landing pads and the bonds of the chip module (TCM; not shown). The interconnection technology is sometimes referred to as TeConnect. A layer (such as an adhesive coated substrate layer) of the card body (CB) supporting the booster antenna (into which the booster antenna may be embedded) is included in the illustration.

FIG. 9B shows a wire-embedded booster antenna (BA) for a smartcard (SC) having a coupler coil (CC) for inductive coupling with the module antenna (MA; not shown) of a transponder chip module (TCM; not shown), and further having a perimeter coil (PC) for communication with a contactless terminal and an extension antenna (EA) for RF tuning and energy harvesting. In this figure, the booster antenna is shown “naked” (i.e., a supporting layer of the card body is not shown, compare FIG. 9A).

CO₂ Laser Irradiation and Interactions with Wood Veneers

Wood surface treatment with CO₂ laser is, aside from cutting, increasingly used to attain proposed changes in wood surface properties, especially those concerning morphology and color. Wood surface treatment with a CO₂ laser causes obvious discoloration. By selecting the right laser parameters, the wood veneer becomes darker and the altered surface color may be recognized as novel in comparison to the original hue.

The main factors underlying the discoloration are heat-induced processes associated with degradation of the carbonyl groups in lignin and in polysaccharides; the splitting of the C═O bonds influences the chromophore content responsible for the natural wood color, in addition to the color modification related to engraving.

A 100-Watt CO₂ RF 1064 nm laser may be used for engraving and cutting of a laminated multi-layered wood veneer assembly having a thickness of 800 μm.

### Coatings & Staining

Coatings include: clear and pigmented polyurethane coatings of wood veneers for chemical and physical resistance; water-based wood coatings for clear and pigmented surfaces; solvent-based and water-based UV coatings; polyester coatings for closed-pore surfaces; acrylic coatings for open-pore surfaces and to enhance the natural beauty of the wood veneer; nitrocellulose coatings; and UV curable coatings for digital printing to enhance the brilliance of colors and the high definition of the print. The application of a coating to a wood veneer may be roll, spray, curtain, vacuum or other coating processes.

The staining of wood veneers highlights the grain and pores, uniforms the differences in shades of the substrate and reduces color changes over time.

### Techniques to Apply Adhesive to a Substrate Layer

Curtain coating is a technology where a thin, even layer of adhesive resin (in liquid form) is applied to a moving substrate (like fleece, paper or the like) by allowing the liquid to fall from a slot or nozzle, forming a “curtain”. This pre-metered coating method allows for precise control of the coating thickness and uniformity.

Roller coating is a technique where a coating of adhesive resin is applied to a substrate (e.g. fleece or paper) using rotating rollers. It's a pre-metered coating process, meaning the amount of coating applied is controlled by the roller's movement and the properties of the adhesive resin.

Adhesive spray coating involves applying a sprayable adhesive from a pressurized container to the surface of a substrate in creating a bondable material.

Adhesive film transfer is used to move dry film adhesive in web form from a backing material (or release film) onto the surface of a substrate.

### Additional Front Layers (AFL) & Additional Rear Layers (ARL)

The additional front layers (AFL) and the additional rear layers (ARL) of an impregnation layer (IL), artwork (AW) and a laser engravable topcoat (TC), as described above, may comprise of a primer, digitally deposited ink and a varnish.

The primer may be applied digitally or by screen printing using a defined mesh (th/cm) to apply a solvent-based screen printing ink (adhesive) in one pass with a thickness of approximately 5 μm (post drying and absorption of the solvent in the pores of the wood veneer). The primer functions as an adhesion promoter, a sealant and as an impregnation layer. Artwork may be digitally deposited on the primed surface, resulting in CMYK ink thickness of approximately 15 μm. Post digital printing, a topcoat of matt or gloss varnish may be applied by way of screen printing to protect the underlying graphics from scratches. The varnish may be a UV based thermo-adhesive, with a post curing thickness of approximately 7 μm (depending on the mesh size and number of passes). The total thickness of the impregnation layer, printed ink and varnish may be ~27 μm on each side of the card body. The varnish also facilitates the application of the magnetic stripe and the hot stamping of security elements, such as a holographic foil or signature panel. The varnish may be laser engravable.

The surface roughness of the exposed wood veneer layers (front and rear faces) in a laminated sheet assembly has an Ra value of approximately 5 μm. By screen printing a UV varnish to the exposed surface, the surface roughness drops to 2 μm.

FIGS. 10A, 10B and 10C illustrate embedding coated wire (CW) for a booster antenna (BA) in an adhesive layer (AL) on a support layer (SL). The thickness of an adhesive layer receiving the wire, which may be a coated wire (CW) is sufficient to receive the wire which may be embedded in the adhesive layer using an ultrasonic tool (sonotrode).

### FIG. 7E (Modified Lamination Parameters and Materials)

FIG. 7E shows a stack-up assembly having an overall thickness of 1350 μm comprising a front subassembly (FS: WL/150 μm+ACSL/150 μm), a 3-ply core subassembly (CS: WL/150 μm+an embedded booster antenna circuit (BAC) integrated or incorporated into an ACSL/150 μm+WL/150 μm+ACSL/150 μm+WL/150 μm); and a rear subassembly (RS: ACSL/150 μm+WL/150 μm).

Prelamination of the 3-ply Core Subassembly

The spread in the post lamination thickness across the core subassembly (CS) in a production format of 25-up to create a pre-laminate, comprising three layers of rotary peeled wood veneer (WL, PWL/3×150 μm), an adhesive coated substrate layer (ACSL/150 μm) incorporating an array of booster antenna circuits (BAC) and an additional adhesive coated substrate layer (ACSL/150 μm) for interlayer bonding and reinforcement, is between 480 μm and 545 μm, representing a shrinkage from an initial thickness (750 μm) of between 27% and 36%. The reason for this broad spread in the thickness across the laminated subassembly can be attributed to the protrusion of the array of booster antenna circuits.

The core subassembly (CS) with three layers of wood veneer (3-ply construction) may be laminated (at a pressure: 200 N/cm² at a temperature of 135° C. to 150° C. for a dwell time of 6 minutes) resulting in a thickness of approximately 545 μm (27% compression).

### Final Lamination of the Stack-Up Assembly

The stack-up assembly for final lamination (card body subassembly (CBS): 1145 μm) comprising a front rotary peeled wood veneer layer (WL, PWL: 150 μm), an adhesive coated substrate layer (ACSL: 150 μm), the laminated core subassembly (CS: 545 μm), an adhesive coated substrate layer (ACSL: 150 μm) and a rear layer of rotary peeled wood veneer (WL, PWL: 150 μm) may have a post lamination thickness in the range 780 to 810 μm with dimensional outliers.

Final lamination (at a pressure of 200 N/cm² at a temperature of 135° C. to 150° C. for a dwell time of 6 minutes) results in a shrinkage between 29 and 32%.

### Glass Fiber Nonwoven Fabric as Reinforcement Layer

The 5-ply stack-up construction in FIG. 7E may be modified to enhance the robustness and stiffness of the card body structure by replacing the reinforcement layers (adhesive coated substrate layers of nonwoven fabric) with a glass fiber nonwoven fabric.

The assembly may comprise five layers of wood veneer and three 3 layers of glass fiber nonwoven fabric coated on both sides with an adhesive for interlayer bonding and one layer of a wetlaid nonwoven fabric coated on both sides with a thermoplastic adhesive to incorporate a booster antenna circuit.

While the invention(s) may have been described with respect to a limited number of embodiments, these should not be construed as limitations on the scope of the invention(s), but rather as examples of some of the embodiments of the invention(s). Those skilled in the art may envision other possible variations, modifications, and implementations that are also within the scope of the invention(s), and claims, based on the disclosure(s) set forth herein.

What is claimed is:

1. A method for manufacturing a wooden transaction card (WTC), comprising:
providing preconditioned wooden (veneer) layers having a moisture content between 6% and 9% from the mill, after drying;
forming a stack-up assembly comprising at least one sliced wooden layer (SWL), at least one micro-thin peeled wooden layer (PWL), and at least one adhesive coated substrate layer (ACSL);
laminating the stack-up assembly to an ISO card thickness of 760-800 μm using a pressure of less than 5 MPa;
wherein no moisture-removal pre-conditioning cycle at elevated temperature and no densification pressure or compression above 5 MPa is applied to the stack-up assembly.

2. The method of claim 1, wherein:
lamination (densification) is performed using (applying) a pressure of less than 5 Mpa to the stack-up.

3. The method of claim 1, wherein:
lamination is performed at a pressure between 200 N/cm² and 500 N/cm² or at a pressure 500 N/cm² and 850 N/cm².

4. The method of claim 1, wherein:
lamination is performed at a temperature between 135° C. and 150° C.

5. The method of claim 1, wherein:
a plurality of stack-up assemblies are laminated simultaneously with one another; and
lamination is performed for a dwell time between 30 and 50 minutes, depending upon the number of assemblies simultaneously being laminated.

6. The method of claim 1, further comprising:
cooling the laminated assembly to ambient temperature and pressure following lamination.

7. The method of claim 1, wherein:
lamination is performed in a single process step.

8. The method of claim 1, further comprising:
separately laminating a core subassembly (CS) prior to laminating the entire stack-up;
wherein the core subassembly comprises an adhesive coated substrate layer (ACSL) and a booster antenna (BA) embedded within the adhesive coated substrate layer.

9. The method of claim 8, wherein:
the booster antenna is ultrasonically scribed into the adhesive coated substrate layer.

10. The method of claim 8, wherein,
the booster antenna is configured for inductive coupling with a dual-interface chip module (TCM).

11. The method of claim 8, further comprising:
upper and lower micro-thin peeled wood layers arranged on opposite sides of the adhesive coated substrate layer; and
wherein the adhesive coated substrate layer functions as a bonding layer and as a reinforcement layer.

12. The method of claim 1, wherein:
the stack-up is laminated in a single step; and
the process parameters for laminating the complete stack-up assembly comprises using a (high) pressure between 200 N/cm² and 850 N/cm² at a temperature between 135° C. and 150° C. for a dwell time between 30 and 50 minutes followed by a cooling cycle to ambient pressure and temperature, thereby compressing the final stack-up assembly to the ISO conforming thickness of 760-800 μm.

13. A method for manufacturing a wooden transaction card (WTC), comprising:
providing preconditioned wood (veneer) layers (WL, PWL, SWL) having a moisture content between 6% and 9% (from the mill after drying);
forming a stack-up assembly comprising at least one sliced wood layer (SWL), at least one micro-thin peeled wood layer (PWL), and at least one adhesive coated substrate layer (SL); and
laminating the stack-up assembly to an ISO card thickness of 760-800 μm using a pressure of less than 9 MPa;
wherein no moisture-removal pre-conditioning cycle at elevated temperature is applied to the stack-up assembly.

14. The method of claim 13, further comprising:
incorporating a booster antenna (BA; BAC) into the assembly.

15. The method of claim 13, wherein:
lamination is performed in a single process step.
